(19) United States
(12) Patent Application Publication
(10) Pub. No.: US 2024/0063425 A1
(43) Pub. Date: Feb. 22, 2024

(54) Method for producing a crystalline solid electrolyte, a crystalline solid electrolyte, and an electrode combined material and a lithium ion battery using it

(71) Applicant: Idemitsu Kosan Co., Ltd., Tokyo (JP)

(72) Inventor: Tomoyuki OKUYAMA, Ichihara-shi (JP)

(73) Assignee: Idemitsu Kosan Co., Ltd., Tokyo (JP)

(21) Appl. No.: 18/195,439

(22) Filed: May 10, 2023

(30) Foreign Application Priority Data
May 13, 2022 (JP) 2022-079591

(51) Int. Cl. H01M 10/0562; H01M 10/0525; H01M 4/62; C01B 25/14

(52) U.S. Cl. CPC H01M 10/0562; H01M 10/0525; H01M 4/62; C01B 25/14; H01M 2300/008; C01P 2006/40

(57) ABSTRACT

Provided are a method for producing a crystalline sulfide solid electrolyte, the method including mixing a raw material-containing substance that contains a lithium atom, a sulfur atom, a phosphorus atom, and a halogen atom to provide a reaction product, heating the reaction product to provide a crystalline product, and subjecting the crystalline product to a grinding treatment to amorphize at least a part of a surface of the crystalline product, the grinding treatment being performed with an integrated power of 1 (Wh/kg) or more and 500 (Wh/kg) or less; a crystalline sulfide solid electrolyte; and an electrode combined material and a lithium ion battery using it.

### TECHNICAL FIELD

The present invention relates to a method for producing a crystalline sulfide solid electrolyte, a crystalline sulfide solid electrolyte, and an electrode combined material and a lithium ion battery that include the crystalline sulfide solid electrolyte.

### BACKGROUND ART

With the rapid spread of information-related instruments and communication instruments, such as personal computers, video cameras, and mobile phones, in recent years, the development of batteries utilized as power sources therefor is considered to be important. While the batteries applied to the purpose have use an electrolytic solution containing a flammable organic solvent, there has been a concern about the safety, in terms of leakage, ignition, and the like, of such an electrolytic solution in use in batteries due to the liquid form and flammability of the electrolytic solution. In particular, in in-vehicle application, since increases in volume and output are demanded, the concern about the safety has been increasing in batteries using such a conventional electrolytic solution. Thus, a fully solid battery which has a solid electrolyte layer in place of the electrolytic solution is being developed since the fully solid battery which uses no flammable organic solvent therein can simplify the safety system and is excellent in production cost and productivity.

As a solid electrolyte used in a solid electrolyte layer of the fully solid battery, various types have been developed, and, in particular, development of a solid electrolyte having a high ionic conductivity has been actively promoted. Examples of such a solid electrolyte include a solid electrolyte containing lithium as a conductive species, such as an Li₂S—P₂S₅-based solid electrolyte as disclosed in PTL 1, solid electrolytes containing halogen atoms, such as an Li₂S—P₂S₅—LiI-based sulfide solid electrolyte as disclosed in PTL 2 and an Li₂S—P₂S₅—LiI—LiBr-based sulfide solid electrolyte as disclosed in PTLs 3 and 4.

A solid electrolyte can be used for a positive electrode, a negative electrode, and a solid electrolyte layer of a fully solid battery, and in an electrode (positive electrode, negative electrode), a solid electrolyte and an electrode active substance (positive electrode active substance, negative electrode active substance) are used in combination. Since the solid electrolyte and the electrode active substance are both a solid electrolyte, the solid electrolyte desirably has a small particle diameter given that a contact interface between the electrode active substance and the solid electrolyte is more easily formed and paths of the ion conduction and the electron conduction are improved, resulting in superior battery performance. Thus, a technique for reducing the particle diameter of a solid electrolyte (hereinafter referred to also as “grain refinement”) also attracts attention. As a technique of grain refinement of a solid electrolyte, a technique of grain refinement with a grinding apparatus is disclosed, for example, in PTL 5, and, a production method including a step of adding an ether compound to a coarse grain material as a sulfide solid electrolyte material and performing grain refinement with a grinding treatment is disclosed, for example, in PTL 6.

### CITATION LIST

### Patent Literature

PTL 1: JP 2005-228570 A
PTL 2: JP 2013-201110 A
PTL 3: WO 2014/208180
PTL 4: WO 2014/208239
PTL 5: JP 2016-203087 A
PTL 6: JP 2013-020894 A

### SUMMARY OF INVENTION

### Technical Problem

The present invention was made in view of the above situation, and an object of the present invention is to provide a crystalline sulfide solid electrolyte that has a superior oxidation resistance while suppressing granulation, an increase in the specific surface area, and a significant reduction in the ionic conductivity, and to provide an electrode combined material and a lithium ion battery that use the crystalline sulfide solid electrolyte.

### Solution to Problem

The method for producing a crystalline sulfide solid electrolyte according to the present invention is a method for producing a crystalline sulfide solid electrolyte, the method including
mixing a raw material-containing substance containing a lithium atom, a sulfur atom, a phosphorus atom, and a halogen atom to provide a reaction product,
heating the reaction product to provide a crystalline product, and
subjecting the crystalline product to a grinding treatment to amorphize at least a part of a surface of the crystalline product,
the grinding treatment being performed at an integrated power of 1 (Wh/kg) or more and 500 (Wh/kg) or less.

The crystalline sulfide solid electrolyte according to the present invention is a crystalline sulfide solid electrolyte
containing a lithium atom, a sulfur atom, a phosphorus atom, and a halogen atom, and
having an amorphized part as at least a part of a surface of the crystalline sulfide solid electrolyte.

The electrode combined material according to the present invention is an electrode combined material containing
the crystalline sulfide solid electrolyte and an electrode active substance.

The lithium ion battery according to the present invention is a lithium ion battery containing
at least one of the crystalline sulfide solid electrolyte and the electrode combined material.

### Advantageous Effects of Invention

According to the present invention, it is possible to provide a crystalline sulfide solid electrolyte that has a superior oxidation resistance while suppressing granulation, an increase in the specific surface area, and a significant reduction in the ionic conductivity, and to provide an electrode combined material and a lithium ion battery that use the crystalline sulfide solid electrolyte.

### BRIEF DESCRIPTION OF DRAWINGS

FIG. 1 shows an X-ray diffraction spectrum of a powder obtained in Example 1.

FIG. 2 shows CV curves of powders obtained in Example 1 and Comparative Example 1.

### DESCRIPTION OF EMBODIMENTS

An embodiment of the present invention (hereinafter sometimes referred to as “this embodiment”) will be described below. In the description herein, the upper limit values and the lower limit values relating to the numerical ranges accompanied with “or more”, “or less”, and “to”, are numerical values that can be optionally combined, and the values in the Examples can be used as the upper limit values and the lower limit values. Preferred definitions can be optionally adopted. In other words, one preferred definition can be adopted in combination with another preferred definition or other preferred definitions. Combination of preferred definitions is more preferred.

(Findings that the Present Inventor has Acquired to Achieve the Present Invention)

As a result of intensive and extensive studies for solving the above problem, the present inventor has found the following items, thus completing the present invention.

As a solid electrolyte to be used in a fully solid battery, from the viewpoint of achieving higher battery performance, as described above, a solid electrolyte containing lithium as a conductive species is preferred. In other words, as a fully solid battery, a fully solid lithium secondary battery is preferred. In electrodes (positive electrode, negative electrode) of a fully solid battery, a solid electrolyte and an electrode active substance (positive electrode active substance, negative electrode active substance) are used in combination, and more specifically, an electrode combined material containing at least a solid electrolyte, an electrode active substance, and a conductive agent is used. For achieving superior battery characteristics, good paths of ion conduction and electric conduction are essential.

For example, regarding a positive electrode, as an electric conduction path, it is desirable that electrons flow from a positive electrode collector via a conductive agent in an electrode combined material, and are then passed from the conductive agent to a positive electrode active substance, and that lithium ions are passed from the positive electrode active substance to a solid electrolyte. A potential difference may occur between the conductive agent and the solid electrolyte, and an electrochemical reaction may occur at the interface between the conductive agent and the solid electrolyte. When a negative electrode is used as a reference electrode, a positive potential is applied on a positive electrode combined material, and thus, the electrochemical reaction on the side of the positive electrode at this time is an oxidation reaction. The oxidation reaction leads to degradation of the solid electrolyte, which consequently becomes one factor of increase in the internal resistance in the fully solid battery.

Thus, the present inventor focused on the oxidation reaction occurring at the interface between a conductive agent and a solid electrolyte, and supposed that, by using a solid electrolyte that is less liable to cause the oxidation reaction, an increase in the internal resistance could be suppressed to achieve superior battery characteristics. That is, the present inventor supposed that, by using a solid electrolyte having an oxidation resistance which is a property that is less liable to cause an oxidation reaction, an increase in the internal resistance could be suppressed to achieve superior battery characteristics.

The present inventor examined the oxidation resistances of an amorphous solid electrolyte and a crystalline solid electrolyte by a cyclic voltammetry measurement (CV measurement). Thus, the present inventor has found that the amorphous solid electrolyte shows a lower oxidation degree. Based on the finding, the present inventor supposed that, by amorphizing a part of a crystalline solid electrolyte, a solid electrolyte superior in the oxidation resistance while having a high ionic conductivity could be provided. A grinding treatment is proposed for amorphizing a part of a crystalline solid electrolyte. However, depending on the degree of the grinding treatment, all the particles may be amorphized to significantly reduce the ionic conductivity. In addition, an event in which the particle size distribution varies due to granulation to increase the specific surface area may occur.

In the method for producing a solid electrolyte, a technique of performing a grinding treatment for the purpose of grain refinement is disclosed, for example, in PTLs 5 and 6. More specifically, PTL 5 discloses a method for producing a sulfide solid electrolyte material, the method including a grain refinement step of performing grain refinement with a grinding apparatus using a grinding media to form a sulfide solid electrolyte material having a flat shape, the material having a flat shape and having an average particle diameter of 1.9 μm or less. More specifically, PTL 6 discloses a production method including a step of adding an ether compound to a coarse grain material as a sulfide solid electrolyte material and performing grain refinement by a grinding treatment. However, any of the patent documents is not for providing a crystalline sulfide solid electrolyte, and does not disclose that after once providing a crystalline sulfide solid electrolyte, the crystalline sulfide solid electrolyte is subjected to a grinding treatment nor disclose that at least a part of the surface thereof is amorphized, as in the production method of this embodiment.

As described above, in none of conventional methods of producing a sulfide solid electrolyte, a crystalline sulfide solid electrolyte is once provided and then, the crystalline sulfide solid electrolyte is subjected to a grinding treatment with a specific integrated power to amorphize at least a part of the surface, thereby achieving a superior oxidation resistance while ensuring a high ionic conductivity, and further suppressing granulation and an increase in the specific surface area.

Based on the above findings, the present inventor has found that, in a method for producing a crystalline sulfide solid electrolyte, by subjecting a crystalline sulfide solid electrolyte once obtained by crystallization to a grinding treatment with a specific integrated power, not only granulation, an increase in the specific surface area, and a significant reduction in the ionic conductivity can be suppressed, but also a crystalline sulfide solid electrolyte having a superior oxidation resistance is provided.

### (Sulfide Solid Electrolyte)

Terms used in the description herein will be described first.

In the description herein, “solid electrolyte” means an electrolyte that maintains a solid form at 25° C. under a nitrogen atmosphere. The sulfide solid electrolyte in this embodiment is a solid electrolyte that contains at least a lithium atom and a sulfur atom, has an ionic conductivity attributable to the lithium atom, and also contains a phosphorus atom and a halogen atom.

The “solid electrolyte” encompasses both of an amorphous solid electrolyte and a crystalline solid electrolyte.

In the description herein, the crystalline solid electrolyte is a solid electrolyte that has a peak derived from the solid electrolyte observed in an X-ray diffraction pattern in X-ray diffractometry regardless of the presence of a peak derived from a raw material of the solid electrolyte. In other words, the crystalline solid electrolyte contains a crystal structure derived from a solid electrolyte, and a part of the solid electrolyte may have a crystal structure derived from the solid electrolyte or the whole solid electrolyte may have a crystal structure derived from the solid electrolyte. The crystalline solid electrolyte may contain an amorphous solid electrolyte as a part thereof as long as it has such an X-ray diffraction pattern as above. Accordingly, the crystalline solid electrolyte encompasses a so-called glass ceramic which is obtained by heating an amorphous solid electrolyte to the crystallization temperature or higher.

In the description herein, the amorphous solid electrolyte is a solid electrolyte that shows, in an X-ray diffraction pattern in X-ray diffractometry, a halo pattern in which any peak is substantially not observed except for peaks derived from the raw materials regardless of the presence of a peak derived from a raw material of the solid electrolyte.

### Various Aspects of this Embodiment

A method for producing a crystalline sulfide solid electrolyte according to a first aspect of this embodiment is a method for producing a crystalline sulfide solid electrolyte, including
mixing a raw material-containing substance containing a lithium atom, a sulfur atom, a phosphorus atom, and a halogen atom to provide a reaction product,
heating the reaction product to provide a crystalline product, and
subjecting the crystalline product to a grinding treatment to amorphize at least a part of a surface of the crystalline product,
the grinding treatment being performed with an integrated power of 1 (Wh/kg) or more and 500 (Wh/kg) or less.

In the method for producing a crystalline sulfide solid electrolyte of this embodiment, the reaction product obtained by providing a reaction product results from a reaction of solid-electrolyte raw materials contained in the raw material-containing substance, and contains at least a sulfur atom and a lithium atom, and has an ionic conductivity attributable to the lithium atom. Since the reaction product shows, in an X-ray diffraction pattern in X-ray diffractometry, a halo pattern in which any peak is substantially not observed except for peaks derived from the raw materials, the reaction product can be referred to as an amorphous sulfide solid electrolyte in light of the property.

The crystalline product obtained by heating the reaction product resulting from the mixing can be considered as a product obtained by heating an amorphous sulfide solid electrolyte in light of the property, and thus, has a crystal structure derived from the solid electrolyte. Hence, the crystalline product can be referred to as a crystalline sulfide solid electrolyte in light of the property.

In the production method of this embodiment, by subjecting the thus obtained crystalline product to a grinding treatment with a specific integrated power, at least a part of the surface thereof is amorphized.

In the sulfide solid electrolyte obtained by the production method of this embodiment, since peaks derived from the solid electrolyte are observed in an X-ray diffraction pattern in X-ray diffractometry, the sulfide solid electrolyte can be considered as a crystalline sulfide solid electrolyte, but the peak intensities are lower than those of the above crystalline product. In addition, according to a CV measurement (oxidation current measurement) described in the section of Examples, the oxidation current increases by converting the reaction product to the crystalline product, but the product obtained by subjecting the crystalline product to a grinding treatment with a specific integrated power has an oxidation current reduced to the same degree as that of the reaction product. From the results, it can be said that, in the sulfide solid electrolyte obtained by the production method of this embodiment, while a configuration of a crystalline sulfide solid electrolyte is maintained, a part thereof has been amorphized to become an amorphous sulfide solid electrolyte. Furthermore, given that the surfaces of the crystalline product are to be brought into contact with each other in the grinding treatment of the crystalline product, it can be said that, in the obtained sulfide solid electrolyte, at least a part of the surface of the crystalline product has been amorphized. Thus, it can be said that, by grinding the crystalline product with a specific integrated power, at least a part of the surface thereof can be amorphized.

In the production method of this embodiment, it is important that, after a crystalline sulfide solid electrolyte is once provided, the crystalline sulfide solid electrolyte is subjected to a grinding treatment. By such a configuration, while ensuring the structure of the crystalline sulfide solid electrolyte, at least a part of the surface thereof can be amorphized. Thus, while ensuring the characteristics of the crystalline sulfide solid electrolyte, specifically, a high ionic conductivity, the characteristics of the amorphous sulfide solid electrolyte, specifically, a superior oxidation resistance can be imparted.

It is also important that the amorphization is achieved in at least a part of the surface thereof, in particular, in the surface. It is because, when the whole thereof is amorphized, it is no longer a crystalline sulfide solid electrolyte, and thus a high ionic conductivity cannot be achieved. The limitation of the amorphization to at least a part of the surface can be achieved by limiting the integrated power in the grinding treatment of the crystalline product within a specific range. In the production method of this embodiment, by performing the grinding treatment with an integrated power limited into a specific range, an effect to suppress an increase in the specific surface area, which is accompanied with variation in the particle size distribution due to granulation, can also be attained.

Thus, in the production method of this embodiment, by once providing a crystalline sulfide solid electrolyte and after that, subjecting the crystalline sulfide solid electrolyte to a grinding treatment with a specific integrated power, it is possible to amorphize at least a part of the surface to achieve a superior oxidation resistance while ensuring a high ionic conductivity, and it is also possible to suppress granulation and an increase in the specific surface area.

A method for producing a crystalline sulfide solid electrolyte according to a second aspect of this embodiment is the method of the first aspect in which in the providing a reaction product, the mixing is performed using a grinder.

In the production method of this embodiment, a method for providing the reaction product is not particularly limited as long as the solid-electrolyte raw materials contained in the raw material-containing substance can be mixed to provide a reaction product (that is, amorphous sulfide solid electrolyte), and various methods can be adopted. The method in which mixing is performed using a grinder according to the second aspect is a method that is referred to as a so-called mechanical milling method.

A method for producing a crystalline sulfide solid electrolyte according to a third aspect of this embodiment is the method of the first aspect in which
the providing a reaction product includes
mixing the raw material-containing substance in the presence of a complexing agent to provide a complex, and
heating the complex to provide a complex degradation product.

As described above, as a method for the providing a reaction product, various methods can be adopted, but the method according to the third aspect is according to a liquid phase method (in particular, heterogeneous method) in which a complex containing solid-electrolyte raw materials is formed using a complexing agent and the complex is heated to remove the complexing agent contained in the complex to provide a reaction product (that is, amorphous sulfide solid electrolyte).

While details of the complexing agent will be described later, by using the complexing agent, a complex of a solid-electrolyte raw material and the complexing agent can be formed. Halogen atoms have a property of developing a high ionic conductivity when contained in a sulfide solid electrolyte, but meanwhile, also have a property of being hardly taken in a sulfide solid electrolyte. Since even a solid-electrolyte raw material containing a halogen atom is taken in a complex by using a complexing agent, the dispersion state of the solid-electrolyte raw material, in particular, the dispersion state of the halogen atom is more easily kept uniform, and as a result, a sulfide solid electrolyte having a high ionic conductivity is more easily obtained.

A method for producing a crystalline sulfide solid electrolyte according to a fourth aspect of this embodiment is the method of the first to third aspects in which
the crystalline sulfide solid electrolyte is a sulfide solid electrolyte having a thio-LISICON Region II-type crystal structure.

In the production method of this embodiment, by changing the types and the blending ratio of solid-electrolyte raw materials contained in the raw material-containing substance, a desired sulfide solid electrolyte can be produced. The crystalline sulfide solid electrolyte having a thio-LISICON Region II-type crystal structure is known as a sulfide solid electrolyte having an extremely high ionic conductivity, and is preferable as a crystalline sulfide solid electrolyte to be obtained by the production method of this embodiment.

A crystalline sulfide solid electrolyte according to a fifth aspect of this embodiment is
a crystalline sulfide solid electrolyte containing a lithium atom, a sulfur atom, a phosphorus atom, and a halogen atom,
the crystalline sulfide solid electrolyte having an amorphized part as at least a part of a surface thereof.

The crystalline sulfide solid electrolyte of this embodiment is a crystalline sulfide solid electrolyte that can be easily produced by the production method of this embodiment. By once providing a crystalline sulfide solid electrolyte and after that, subjecting the crystalline sulfide solid electrolyte to a grinding treatment with a specific integrated power, a sulfide solid electrolyte having an amorphized part as at least a part of the surface is obtained. The crystalline sulfide solid electrolyte of this embodiment has a superior oxidation resistance while ensuring a high ionic conductivity, and further has a property of suppressing granulation and an increase in the specific surface area.

A crystalline sulfide solid electrolyte according to a sixth aspect of this embodiment is the crystalline sulfide solid electrolyte of the fifth aspect in which the crystalline sulfide solid electrolyte has a reduction rate in the oxidation current as measured by a cyclic voltammetry measurement (CV measurement) of 10% or more, the reduction rate being calculated by the following expression:

reduction rate in oxidation current (%)=(oxidation current 2−oxidation current 1)/oxidation current 2×100
oxidation current 1: the oxidation current of the crystalline sulfide solid electrolyte that has the amorphized part as at least a part of the surface (mA)
oxidation current 2: the oxidation current of the crystalline sulfide solid electrolyte before providing the amorphized part as at least a part of the surface (mA)

Since the crystalline sulfide solid electrolyte of this embodiment is basically a crystalline sulfide solid electrolyte and has an amorphized part as at least a part of the surface, a superior oxidation resistance which is a property of an amorphous sulfide solid electrolyte, specifically, a property such that the reduction rate in the oxidation current, which is calculated by the above expression with oxidation currents measured by a CV measurement, is as high as 10% or more, is imparted while ensuring a high ionic conductivity which is a property of a crystalline sulfide solid electrolyte.

A crystalline sulfide solid electrolyte according to a seventh aspect of this embodiment is the crystalline sulfide solid electrolyte of the fifth or sixth aspect in which
the sulfide solid electrolyte has a thio-LISICON Region II-type crystal structure.

A sulfide solid electrolyte having a thio-LISICON Region II-type crystal structure is known as a sulfide solid electrolyte having an extremely high ionic conductivity, and is preferable as a crystalline sulfide solid electrolyte to be obtained by the production method of this embodiment.

An electrode combined material according to an eighth aspect of this embodiment is an electrode combined material containing
the crystalline sulfide solid electrolyte of any one of the fifth to seventh aspects and an electrode active substance.

A lithium ion battery according to a nineth aspect of this embodiment is a lithium ion battery containing
at least one of the crystalline sulfide solid electrolyte of any one of the fifth to seventh aspects and the electrode active substance of the eighth aspect.

As described above, the crystalline sulfide solid electrolyte of this embodiment has a superior oxidation resistance while suppressing granulation, an increase in the specific surface area, and a significant reduction in the ionic conductivity. Thus, an electrode combined material containing the crystalline sulfide solid electrolyte of this embodiment and a lithium ion battery using the electrode combined material have superior battery performance.

### [Method for Producing Sulfide Solid Electrolyte]

The method for producing a sulfide solid electrolyte of this embodiment is a method for producing a crystalline sulfide solid electrolyte, including
mixing a raw material-containing substance that contains a lithium atom, a sulfur atom, a phosphorus atom, and a halogen atom to provide a reaction product,
heating the reaction product to provide a crystalline product, and
subjecting the crystalline product to a grinding treatment to amorphize at least a part of a surface of the crystalline product,
the grinding treatment being performed with an integrated power of 1 (Wh/kg) or more and 500 (Wh/kg) or less.

### [Providing a Reaction Product]

The production method of this embodiment includes mixing a raw material-containing substance that contains a lithium atom, a phosphorus atom, a sulfur atom, and a halogen atom to provide a reaction product.

In the production method of this embodiment, a method for providing a reaction product is not particularly limited as long as a reaction product can be obtained by mixing solid-electrolyte raw materials contained in the raw material-containing substance, and various methods may be adopted. Preferred examples of the method for providing a reaction product include the following two methods:
(i) a method in which mixing is performed using a grinder
(ii) a method by mixing the raw material-containing substance in the presence of a complexing agent to provide a complex, and heating the complex to provide a complex degradation product.

### (Method (i) for Providing a Reaction Product)

First, a method (i) for providing a reaction product, a so-called mechanical milling method, will be described from the raw material-containing substance.

### (Raw Material-Containing Substance)

The raw material-containing substance used in this embodiment contains a lithium atom, a sulfur atom, a phosphorus atom, and a halogen atom, and more specifically, is a substance containing a compound containing one or more selected from the group consisting of the atoms (hereinafter also referred to as “solid-electrolyte raw material). The raw material-containing substance used in this embodiment preferably contains two or more solid-electrolyte raw materials.

Typical examples of the solid-electrolyte raw material contained in the raw material-containing substance include raw materials composed of at least two kinds of atoms selected from the above four kinds of atoms, for example, lithium sulfide; lithium halides, such as lithium fluoride, lithium chloride, lithium bromide, and lithium iodide; phosphorus sulfides, such as diphosphorus trisulfide (P₂S₃) and diphosphorus pentasulfide (P₂S₅); and phosphorus halides, such as various phosphorus fluorides (PF₃, PF₅), various phosphorus chlorides (PCl₃, PCl₅, P₂Cl₄), various phosphorus bromides (PBr₃, PBr₅), and various phosphorus iodides (PI₃, P₂I₄); and thiophosphoryl halides, such as thiophosphoryl fluoride (PSF₃), thiophosphoryl chloride (PSCl₃), thiophosphoryl bromide (PSBr₃), thiophosphoryl iodide (PSI₃), thiophosphoryl dichloride fluoride (PSCl₂F), and thiophosphoryl dibromide fluoride (PSBr₂F); and halogen simple substances, such as fluorine (F₂), chlorine (Cl₂), bromine (Br₂), and iodine (I₂), preferably bromine (Br₂) and iodine (I₂).

Examples of a compound that can be used as the solid-electrolyte raw material other than the above compounds include a solid-electrolyte raw material that contains at least one kind of atom selected from the four kinds of atoms and also contains an atom other than the four kinds of atoms, more specifically, lithium compounds, such as lithium oxide, lithium hydroxide, and lithium carbonate; alkali metal sulfides, such as sodium sulfide, potassium sulfide, rubidium sulfide, and cesium sulfide; metal sulfides, such as silicon sulfide, germanium sulfide, boron sulfide, gallium sulfide, tin sulfides (SnS, SnS₂), aluminum sulfide, and zinc sulfide; phosphate compounds, such as sodium phosphate and lithium phosphate; halides of an alkali metal other than lithium, for example, sodium halides, such as sodium iodide, sodium fluoride, sodium chloride, and sodium bromide; metal halides, such as an aluminum halide, a silicon halide, a germanium halide, an arsenic halide, a selenium halide, a tin halide, an antimony halide, a tellurium halide, and a bismuth halide; and phosphorus oxyhalides, such as phosphorus oxychloride (POCl₃) and phosphorus oxybromide (POBr₃).

Among the above compounds, lithium sulfide, a phosphorus sulfide, such as diphosphorus trisulfide (P₂S₃) or diphosphorus pentasulfide (P₂S₅), a halogen simple substance, such as fluorine (F₂), chlorine (Cl₂), bromine (Br₂), or iodine (I₂), and a lithium halide, such as lithium fluoride, lithium chloride, lithium bromide, or lithium iodide, are preferred. When an oxygen atom is to be introduced into the solid electrolyte, lithium oxide, lithium hydroxide, or a phosphate compound, such as lithium phosphate, is preferred. Preferred examples of a combination of solid-electrolyte raw materials include a combination of lithium sulfide, diphosphorus pentasulfide, and a lithium halide and a combination of lithium sulfide, diphosphorus pentasulfide, and a halogen simple substance, and as the lithium halide, lithium bromide and lithium iodide are preferred, and as the halogen simple substance, bromine and iodine are preferred.

In this embodiment, Li₃PS₄ containing a PS₄ structure can be used as a part of raw materials. Specifically, Li₃PS₄ is provided in advance by production or the like, and is used as a raw material.

The content of Li₃PS₄ in the total of the raw materials is preferably 60 to 100% by mole, more preferably 65 to 90% by mole, and further preferably 70 to 80% by mole.

When Li₃PS₄ and a halogen simple substance are used, the content of the halogen simple substance relative to Li₃PS₄ is preferably 1 to 50% by mole, more preferably 10 to 40% by mole, further preferably 20 to 30% by mole, and furthermore preferably 22 to 28% by mole.

The lithium sulfide used in this embodiment is preferably particles.

The average particle diameter (D50) of the lithium sulfide particles is preferably 0.1 μm or more and 1000 μm or less, more preferably 0.5 μm or more and 100 μm or less, and further preferably 1 μm or more and 20 μm or less. In the description herein, the average particle diameter (D50) is the particle diameter, at which the cumulative amount from the side of the particle having the minimum particle diameter in the particle diameter cumulative curve reaches 50% (by volume) of the total, and the volume distribution can be measured, for example, with a laser diffraction-scattering particle diameter distribution analyzer. Among the raw materials mentioned above, a solid raw material preferably has an average particle diameter that is equivalent to that of the lithium sulfide particles, i.e., preferably within the same range as that of the average particle diameter of the lithium sulfide particles.

When lithium sulfide, diphosphorus pentasulfide, and a lithium halide are used as solid-electrolyte raw materials, the proportion of lithium sulfide based on the sum of lithium sulfide and diphosphorus pentasulfide is, from the viewpoint of achieving higher chemical stability and higher ionic conductivity, preferably 70 to 80% by mole, more preferably 72 to 78% by mole, and further preferably 74 to 78% by mole.

When lithium sulfide, diphosphorus pentasulfide, and a lithium halide, and another solid-electrolyte raw material used as needed are used, the content of lithium sulfide and diphosphorus pentasulfide based on the sum thereof is preferably 50 to 100% by mole, more preferably 55 to 90% by mole, and further preferably 60 to 85% by mole.

When lithium bromide and lithium iodide are used in combination as the lithium halide, from the viewpoint of increasing the ionic conductivity, the proportion of lithium bromide based on the sum of lithium bromide and lithium iodide is preferably 1 to 99% by mole, more preferably 20 to 80% by mole, further preferably 30 to 70% by mole, and particularly preferably 40 to 60% by mole.

When a halogen simple substance is used as a solid-electrolyte raw material and lithium sulfide and diphosphorus pentasulfide are used, the proportion of the moles of lithium sulfide except for lithium sulfide of the same moles as the moles of the halogen simple substance based on the total moles of lithium sulfide and diphosphorus pentasulfide except for lithium sulfide of the same moles as the moles of the halogen simple substance is preferably in the rage of 60 to 90%, more preferably in the range of 65 to 85%, and further preferably in the range of 68 to 82%, furthermore preferably in the range of 72 to 78%, and particularly preferably in the range of 73 to 77%. This is because a higher ionic conductivity is obtained with the proportions.

From the same point of view, when lithium sulfide, diphosphorus pentasulfide, and a halogen simple substance are used, the content of the halogen simple substance based on the total amount of lithium sulfide, diphosphorus pentasulfide, and the halogen simple substance is preferably 1 to 50% by mole, more preferably 2 to 40% by mole, further preferably 3 to 25% by mole, and furthermore preferably 3 to 15% by mole.

When lithium sulfide, diphosphorus pentasulfide, a halogen simple substance, and a lithium halide are used, the content (a % by mole) of the halogen simple substance and the content (8% by mole) of the lithium halide based on the total amount thereof preferably satisfy the following expression (2), more preferably satisfy the following expression (3), further preferably satisfy the following expression (4), and furthermore preferably satisfy the following expression (5).

2≤2α+β≤100 (2)

4≤2α+β≤80 (3)

6≤2α+β≤50 (4)

6≤2α+β≤30 (5)

When two kinds of halogen are used as the simple substance, with the number of moles of one halogen atom in the substance being taken as A1 and the number of moles of the other halogen atom in the substance as A2, A1:A2 is preferably 1 to 99:99 to 1, more preferably 10:90 to 90:10, further preferably 20:80 to 80:20, and furthermore preferably 30:70 to 70:30.

When the two halogen simple substances are bromine and iodine, with the number of moles of bromine being taken as B1 and the number of moles of iodine as B2, B1:B2 is preferably 1 to 99:99 to 1, more preferably 15:85 to 90:10, further preferably 20:80 to 80:20, furthermore preferably 30:70 to 75:25, and particularly preferably 35:65 to 75:25.

### (Grinder)

In the method (i) for providing a reaction product, mixing of solid-electrolyte raw materials contained in the raw material-containing substance is performed using a grinder.

While the grinder literally means a machine used in grinding, stirring and mixing may occur together with the grinding. Accordingly, mixing of the solid electrolyte can be performed using a grinder.

As a grinder usable in the production method of this embodiment, any grinder that can mix solid-electrolyte raw materials can be used with no particular limitation, and, for example, a medium-type grinder using a grinding medium can be used.

Medium-type grinders are roughly classified into container-driven grinders and medium-stirring grinders. Examples of the container-driven grinders include a stirring vessel, a grinding vessel, and a ball mill and a bead mill which are a combination thereof. Examples of the medium-stirring grinder include various grinders, for example, an impact-type grinder, such as a cutter mill, a hummer mill, or a pin mill; a column-type grinder, such as tower mill; a stirring vessel-type grinder, such as an attritor, an aquamizer, or a sand grinder; a flow-through vessel-type grinder, such as a viscomill or a pearl mill; a flow-through tube-type grinder; an annular-type grinder, such as a co-ball mill; a continuous dynamic-type grinder; and a single screw or multi-screw kneader.

In view of the easiness of control of the particle diameter of the resulting reaction product, a ball mill and a bead mill exemplified as a container-driven grinder are preferred, and among them, those of a planetary type are preferred.

The grinder can be appropriately selected according to the desired scale or the like, and in the case of a relatively small scale, a container-driven grinder, such as a ball mill or a bead mill, can be used, and in the case of a large scale or mass production, another type of grinder may be used.

When a liquid, such as a solvent, is involved in mixing, in other words, when the substance to be mixed is in a liquid state or in a slurry state, a wet-type grinder which can be applied in a wet grinding is preferred.

Typical examples of the wet-type grinder include a wet bead mill, a wet ball mill, a wet vibrating mill, and the like, and a wet bead mill using beads as grinding media is preferred in that the conditions of the grinding operation can be freely controlled and that it is easily applied to a substance of a smaller particle diameter. A dry-type grinder, for example, a dry medium grinder, such as a dry bead mill, a dry ball mill, or a dry vibrating mill, or a dry non-medium grinder, such as a jet mill, can also be used.

When the subject to be mixed is in a liquid state or in a slurry state, a flow-through-type grinder capable of performing a cycle operation in which the substance is circulated as needed can be used. Specifically, a grinder of a system in which a substance is circulated between a grinder (grinding-mixing machine) that grinds a slurry and a thermostat vessel (reaction container) is exemplified. A grinder (one-path-type), which is not the aforementioned flow-through-type grinder capable of performing a cycle operation, can also be used.

The size of the beads or balls used in the ball mill or the bead mill may be appropriately selected according to the desired particle diameter or an amount to be treated. For example, the diameter of the beads is generally 0.03 mmφ or more, preferably 0.1 mmφ or more, and more preferably 0.3 mmφ or more, and as the upper limit, generally 5.0 mmφ or less, preferably 3.0 mmφ or less, and more preferably 2.0 mmφ or less. The diameter of the balls is generally 2.0 mmφ or more, preferably 2.5 mmφ or more, and more preferably 3.0 mmφ or more, and as the upper limit, generally 20.0 mmφ or less, preferably 15.0 mmφ or less, and more preferably 10.0 mmφ or less.

Examples of the material thereof include metals, such as stainless steel, chromium steel, and tungsten carbide; ceramics, such as zirconia and silicon nitride; and a mineral, such as egate.

When a ball mill or a bead mill is used, the rotation speed cannot be completely specified since it depends on the scale to be treated, but is generally 10 rpm or more, preferably 20 rpm or more, and more preferably 50 rpm or more, and as the upper limit, generally 1,000 rpm or less, preferably 900 rpm or less, more preferably 800 rpm or less, and further preferably 700 rpm or less.

The grinding time in this case cannot be completely specified since it depends on the scale to be treated, but is generally 0.5 hours or more, preferably 1 hour or more, and more preferably 2 hours or more, and as the upper limit, generally 100 hours or less, preferably 72 hours or less, more preferably 48 hours or less, further preferably 24 hours or less, and furthermore preferably 10 hours or less.

### (Solvent)

In method (i) for providing a reaction product, a solvent may be used as described above. As the solvent, a solvent that has been used in a conventional method in production of a solid electrolyte can widely be employed.

Examples of such a solvent include solvents containing a carbon atom, for example, hydrocarbon solvents, such as an aliphatic hydrocarbon solvent, an alicyclic hydrocarbon solvent, and an aromatic hydrocarbon solvent, an alcohol solvent, an ester solvent, an aldehyde solvent, a ketone solvent, a nitrile solvent, an ether solvent in which the number of carbon atoms on one side is 4 or more, and a solvent having a carbon atom and a heteroatom.

More specific examples include solvents that are listed as a solvent that can be used in the method (ii) for providing a reaction product described later.

### (Method (ii) for Providing a Reaction Product)

The method (ii) for providing a reaction product is a method by mixing a raw material-containing substance in the presence of a complexing agent to provide a complex and heating the complex to provide a complex degradation product.

As the raw material-containing substance used in the method (ii), one described as the raw material-containing substance that can be used in the method (i) can be used.

### (Complexing Agent)

The complexing agent is, as described above, a compound that is liable to form a complex with a solid-electrolyte raw material contained in the raw material-containing substance, and, for example, a compound that can form a complex with lithium sulfide and diphosphorus pentasulfide which are preferably used as solid-electrolyte raw materials, or with Li₃PS₄ which is obtained when the lithium sulfide and diphosphorus pentasulfide are used, and further with a solid-electrolyte raw material containing a halogen atom (hereinafter these are also collectively referred to as “solid-electrolyte raw materials, etc.”).

As the complexing agent, any compound that has the property described above can be used with no particular limitation, and, in particular, a compound containing an atom having high affinity to lithium atom, for example, a heteroatom, such as a nitrogen atom, an oxygen atom, or a chlorine atom, is preferred, and a compound having a group containing such a heteroatom is more preferably exemplified. This is because such a heteroatom and a group containing such a heteroatom can coordinate on (bind to) lithium.

It is considered that the heteroatom present in the molecule of the complexing agent has high affinity to the lithium atom and has a property of easily binding to the solid-electrolyte raw materials, etc. to form a complex (hereinafter also referred to simply as “complex”). Thus, it is considered that a complex is formed by mixing the solid-electrolyte raw materials and the complexing agent, and the dispersion state of the solid-electrolyte raw materials, in particular, the dispersion state of halogen atoms is more easily kept uniform, resulting in a sulfide solid electrolyte having a high ionic conductivity.

The fact that the complexing agent can form a complex with the solid-electrolyte raw materials, etc. is directly confirmed by infrared spectroscopy, for example, measured by FT-IR analysis (a diffuse reflectance method).

When a powder obtained by stirring tetramethylethylenediamine (hereinafter simply referred to as “TMEDA”) which is one of preferred complexing agents as the complexing agent and lithium iodide (LiI), and the complexing agent itself are analyzed by FT-IR analysis (a diffuse reflectance method), the obtained spectrum is different from the spectrum of TMEDA itself, particularly in the peak derived from C—N stretching vibration at 1000 to 1250 cm⁻¹. In addition, in light of a known fact that an LiI-TMEDA complex is formed by mixing TMEDA and lithium iodide with stirring (for example, Aust. J. Chem., 1988, 41, 1925-34, in particular, FIG. 2 etc.) and the like, formation of an LiI-TMEDA complex is reasonably believed.

For example, when a powder obtained by stirring the complexing agent (TMEDA) and Li₃PS₄ is similarly analyzed by FT-IR analysis (a diffuse reflectance method), it can be found that the obtained spectrum is different from a spectrum of TMEDA itself in a peak derived from C—N stretching vibration at 1000 to 1250 cm⁻¹, but on the other hand, resembles a spectrum of the LiI-TMEDA complex. Accordingly, formation of an Li₃PS₄-TMEDA complex is believed.

The complexing agent preferably has in the molecule at least two coordinable (bindable) heteroatoms, and more preferably has in the molecule a group containing at least two heteroatoms. When the complexing agent has in the molecule a group containing at least two heteroatoms, the solid-electrolyte raw materials, etc. can be bound via at least two heteroatoms in the molecule. Among heteroatoms, a nitrogen atom is preferred, and as a group containing a nitrogen atom, an amino group is preferred. In other words, the complexing agent is preferably an amine compound.

The amine compound is not particularly limited as long as it has an amino group in the molecule since such a compound can promote formation of a complex, but is preferably a compound having at least two amino groups in the molecule. With such a structure, the solid-electrolyte raw materials, etc. can be bound via at least two nitrogen atoms in the molecule to form a complex.

Examples of such an amine compound include amine compounds, such as an aliphatic amine, an alicyclic amine, a heterocyclic amine, and an aromatic amine, and one of the amine compounds can be used alone or two or more thereof can be used in combination.

More specifically, typical preferred examples of the aliphatic amine include aliphatic diamines, for example, aliphatic primary diamines, such as ethylenediamine, diaminopropane, and diaminobutane; aliphatic secondary diamines, such as N,N′-dimethylethylenediamine, N,N′-diethylethylenediamine, N,N′-dimethyldiaminopropane, and N,N′-diethyldiaminopropane; aliphatic tertiary diamines, such as N,N,N′,N′-tetramethykliaminomethane, N,N,N′,N′-tetramethylethylenediamine, N,N,N′,N′-tetraethylethylenediamine, N,N,N′,N′-tetramethyldiaminopropane, N,N,N′,N′-tetraethykliaminopropane, N,N,N′,N′-tetramethyldiaminobutane, N,N,N′,N′-tetramethyldiaminopentane, and N,N,N′,N′-tetramethykliaminohexane. Here, the listed examples of the description herein encompass all the isomers, for example, in diaminobutane, unless otherwise specified, isomers regarding the positions of the amino groups, such as 1,2-diaminobutane, 1,3-diaminobutane, and 1,4-diaminobutane, and regarding the butane, linear or branched isomers.

The number of carbon atoms of the aliphatic amine is preferably 2 or more, more preferably 4 or more, and further preferably 6 or more, and as the upper limit, preferably 10 or less, more preferably 8 or less, and further preferably 7 or less. The number of carbon atoms of the aliphatic hydrocarbon group in the aliphatic amine is preferably 2 or more, and as the upper limit, preferably 6 or less, more preferably 4 or less, and further preferably 3 or less.

Typical preferred examples of the alicyclic amine include alicyclic diamines, for example, alicyclic primary diamines, such as cyclopropanediamine and cyclohexanediamine; an alicyclic secondary diamine, such as bisaminomethylcyclohexane; and alicyclic tertiary diamines, such as N,N,N′,N′-tetramethyl-cyclohexanediamine and bis(ethylmethylamino)cyclohexane. Typical preferred examples of the heterocyclic amine include heterocyclic diamines, for example, a heterocyclic primary diamine, such as isophoronediamine; heterocyclic secondary diamines, such as piperazine and dipiperidylpropane; and heterocyclic tertiary diamines, such as N,N-dimethylpiperazine and bismethylpiperidylpropane.

The numbers of carbon atoms of the alicyclic amine and the heterocyclic amine are preferably 3 or more, and more preferably 4 or more, and as the upper limit, preferably 16 or less, and more preferably 14 or less.

Typical preferred examples of the aromatic amine include aromatic diamines, for example, aromatic primary diamines, such as phenykliamine, tolylenediamine, and naphthalenediamine; aromatic secondary diamines, such as N-methylphenylenediamine, N,N′-dimethylphenylenediamine, N,N′-bismethylphenylphenylenediamine, N,N′-dimethylnaphthalenediamine, and N-naphthylethylenediamine; aromatic tertiary diamines, such as N,N-dimethylphenylenediamine, N,N,N′,N′-tetramethylphenylenediamine, N,N,N′,N′-tetramethyldiaminodiphenylmethane, and N,N,N′,N′-tetramethylnaphthalenediamine.

The number of carbon atoms of the aromatic amine is preferably 6 or more, more preferably 7 or more, and further preferably 8 or more, and as the upper limit, preferably 16 or less, more preferably 14 or less, and further preferably 12 or less.

The amine compound used in this embodiment may be substituted with a substituent, such as an alkyl group, an alkenyl group, an alkoxy group, a hydroxy group, a cyano group, or a halogen atom.

While diamines are mentioned as specific examples, the amine compound that can be used in this embodiment is of course not limited to diamines, and, for example, trimethylamine, triethylamine, ethyldimethylamine, aliphatic monoamines corresponding to the various diamines, such as the aforementioned aliphatic diamines, piperidine compounds, such as piperidine, methylpiperidine, and tetramethylpiperidine, pyridine compounds, such as pyridine and picoline, morpholine compounds, such as morpholine, methylmorpholine, and tiomorpholine, imidazole compounds, such as imidazole and methylimidazole, monoamines, for example, alicyclic monoamines, such as monoamines corresponding to the aforementioned alicyclic diamines, heterocyclic monoamines corresponding to the aforementioned heterocyclic diamines, aromatic monoamines corresponding to the aforementioned aromatic diamines, and in addition, for example, polyamines having three or more amino groups, such as diethylenetriamine, N,N′,N″-trimethyldiethylenetriamine, N,N,N′,N″,N″-pentamethykliethylenetriamine, triethylenetetramine, N,N′-bis[(dimethylamino)ethyl]-N,N′-dimethylethylene diamine, hexamethylenetetramine, and tetraethylenepentamine, can also be used.

Among them, from the viewpoint of attaining a higher ionic conductivity, a tertiary amine having a tertiary amino group as an amino group is preferred, a tertiary diamine having two tertiary amino groups is more preferred, a tertiary diamine having two tertiary amino groups respectively at two ends thereof is further preferred, and an aliphatic tertiary diamine having a tertiary amino group at both the ends thereof is furthermore preferred. In the amine compounds, as the aliphatic tertiary diamine having a tertiary amino group at both the ends, tetramethylethylenediamine, tetraethylethylenediamine, tetramethyldiaminopropane, and tetraethykliaminopropane are preferred, and in view of availability and the like, tetramethylethylenediamine and tetramethyldiaminopropane are preferred.

With a compound having a group containing a nitrogen atom as a heteroatom other than an amino group, for example, a nitro group or an amide group, the same effect as above can be achieved.

In the production method of this embodiment, as a complexing agent, besides the compound containing a nitrogen atom as a heteroatom, a compound having an oxygen atom is also preferred.

As the compound containing an oxygen atom, a compound having one or more functional groups selected from an ether group and an ester group as the group containing an oxygen atom is preferred, and among them, a compound having an ether group is particularly preferred. In other words, as the complexing agent containing an oxygen atom, an ether compound is particularly preferred.

Examples of the ether compound include an aliphatic ether, an alicyclic ether, a heterocyclic ether, and an aromatic ether, and one of the ether compounds can be used alone or two or more thereof can be used in combination.

More specifically, examples of the aliphatic ether include monoethers, such as dimethyl ether, diethyl ether, diisopropyl ether, dibutyl ether, and tert-butyl methyl ether; diethers, such as dimethoxymethane, dimethoxyethane, diethoxymethane, and diethoxyethane; polyethers having three or more ether groups, such as diethylene glycol dimethyl ether (diglyme) and triethylene oxide glycol dimethyl ether (triglyme); and ethers containing a hydroxy group, such as diethylene glycol and triethylene glycol.

The number of carbon atoms of the aliphatic ether is preferably 2 or more, more preferably 3 or more, and further preferably 4 or more, and as the upper limit, preferably 10 or less, more preferably 8 or less, and further preferably 6 or less.

The number of carbon atoms of the aliphatic hydrocarbon group in the aliphatic ether is preferably 1 or more, and as the upper limit, preferably 6 or less, more preferably 4 or less, and further preferably 3 or less.

Examples of the alicyclic ether include ethylene oxide, propylene oxide, tetrahydrofuran, tetrahydropyran, dimethoxytetrahydrofuran, cyclopentyl methyl ether, dioxane, and dioxolane, and examples of the heterocyclic ether include furan, benzofuran, benzopyran, dioxene, dioxin, morpholine, methoxyindole, and hydroxymethyldimethoxypyridine.

The numbers of carbon atoms of the alicyclic ether and the heterocyclic ether are preferably 3 or more, and more preferably 4 or more, and as the upper limit, preferably 16 or less, and more preferably 14 or less.

Examples of the aromatic ether include methyl phenyl ether (anisole), ethyl phenyl ether, dibenzyl ether, diphenyl ether, benzyl phenyl ether, and naphthyl ether.

The number of carbon atoms of the aromatic ether is preferably 7 or more, and more preferably 8 or more, and as the upper limit, preferably 16 or less, more preferably 14 or less, and further preferably 12 or less.

The ether compound used in this embodiment may be substituted with a substituent, such as an alkyl group, an alkenyl group, an alkoxy group, a hydroxy group, or a cyano group, or a halogen atom.

Among the ether compounds, from the viewpoint of attaining a higher ionic conductivity, an aliphatic ether is preferred, and dimethoxyethane and tetrahydrofuran are more preferred.

Examples of the ester compound include an aliphatic ester, an alicyclic ester, a heterocyclic ester, and an aromatic ester, and one of the ester compounds can be used alone or two or more thereof can be used in combination.

More specifically, examples of the aliphatic ester include formic acid esters, such as methyl formate, ethyl formate, and triethyl formate, acetic acid esters, such as methyl acetate, ethyl acetate, propyl acetate, isopropyl acetate, butyl acetate, and isobutyl acetate; propionic acid esters, such as methyl propionate, ethyl propionate, propyl propionate, and butyl propionate, oxalic acid esters, such as dimethyl oxalate and diethyl oxalate; malonic acid esters, such as dimethyl malonate and diethyl malonate; and succinic acid esters, such as dimethyl succinate and diethyl succinate.

The number of carbon atoms of the aliphatic ester is preferably 2 or more, more preferably 3 or more, and further preferably 4 or more, and as the upper limit, preferably 10 or less, more preferably 8 or less, and further preferably 7 or less. The number of carbon atoms of the aliphatic hydrocarbon group in the aliphatic ester is preferably 1 or more, and more preferably 2 or more, and as the upper limit, preferably 6 or less, more preferably 4 or less, and further preferably 3 or less.

Examples of the alicyclic ester include methyl cyclohexanecarboxylate, ethyl cyclohexanecarboxylate, dimethyl cyclohexanedicarboxylate dibutyl cyclohexanedicarboxylate, and dibutyl cyclohexenedicarboxylate. Examples of the heterocyclic ester include methyl pyridinecarboxylate, ethyl pyridinecarboxylate, propyl pyridinecarboxylate, methyl pyrimidinecarboxylate, ethyl pyrimidinecarboxylate, and lactones, such as acetolactone, propiolactone, butyrolactone, and valerolactone.

The numbers of carbon atoms of the alicyclic ester and the heterocyclic ester are preferably 3 or more, and more preferably 4 or more, and as the upper limit, preferably 16 or less, and more preferably 14 or less.

Examples of the aromatic ester include benzoic acid esters, such as methyl benzoate, ethyl benzoate, propyl benzoate, and butyl benzoate; phthalic acid esters, such as dimethyl phthalate, diethyl phthalate, dibutyl phthalate, butylbenzyl phthalate, and dicyclohexyl phthalate; and trimellitic acid esters, such as trimethyl trimellitate, triethyl trimellitate, tripropyl trimellitate, tributyl trimellitate, and trioctyl trimellitate.

The number of carbon atoms of the aromatic ester is preferably 8 or more, and more preferably 9 or more, and as the upper limit, preferably 16 or less, more preferably 14 or less, and further preferably 12 or less.

The ester compound used in this embodiment may be substituted with a substituent, such as an alkyl group, an alkenyl group, an alkoxy group, a hydroxy group, or a cyano group, or a halogen atom.

Among the ester compounds, from the viewpoint of attaining a higher ionic conductivity, an aliphatic ester is preferred, an acetic acid ester is more preferred, and ethyl acetate is particularly preferred.

Regarding the amount of the complexing agent added, from the viewpoint of efficiently forming a complex, the molar ratio of the amount of the complexing agent added based on total moles of the lithium atoms contained in the raw material-containing substance (moles of additive/total moles of lithium atoms) is preferably 0.1 or more and 10.0 or less, more preferably 0.5 or more and 8.0 or less, and further preferably 0.8 or more and 5.0 or less.

### (Mixing)

In the method (ii) for providing a reaction product, the solid-electrolyte raw materials and the complexing agent are mixed. By mixing them, a complex composed of the solid-electrolyte raw materials and the complexing agent is obtained.

In this embodiment, the form in mixing the solid-electrolyte raw materials and the complexing agent may be either of a solid form or a liquid form, but since the solid-electrolyte raw materials contain a solid and the complexing agent is in a liquid form, in general, mixing is performed in a form such that a solid-electrolyte raw material in a solid form is present in a complexing agent in a liquid form. In mixing the raw material and the complexing agent, a solvent may be further mixed as needed. Hereinafter, in a description about mixing of a raw material and a complexing agent, unless otherwise specified, a solvent which is added as needed is also included in the complexing agent.

The method for mixing a solid-electrolyte raw material and a complexing agent is not particularly limited, and the solid-electrolyte raw material and the complexing agent may be put into an apparatus that is capable of mixing the solid-electrolyte raw material and the complexing agent and mixed. For example, the complexing agent is supplied into a vessel, a stirring blade is activated, and then the solid-electrolyte raw material is portionwise added, whereby a good mixing state of the solid-electrolyte raw material can be achieved to enhance the dispersibility of the raw material, which is preferable.

However, when a halogen simple substance is used as a solid-electrolyte raw material, the solid-electrolyte raw material is sometimes not solid. Specifically, fluorine and chlorine are gas and bromine is liquid under normal temperature and normal pressure. In such a case, for example, when a solid-electrolyte raw material is liquid, the solid-electrolyte raw material may be supplied into a vessel together with the complexing agent separately from the other solid solid-electrolyte raw materials in a solid form. When a solid-electrolyte raw material is gas, the solid-electrolyte raw material may be supplied by being blown into the complexing agent having a solid-electrolyte raw material in a solid form added therein.

In the method (ii) for providing a reaction product, it is only required to mix solid-electrolyte raw materials and a complexing agent and grinding is not required. Thus, unlike the method (i), it is not required to use a machine to be used for the purpose of grinding solid-electrolyte raw materials, which is generally referred to as a grinder, for example, a medium-type grinder, such as a ball mill or a bead mill. In the production method of this embodiment, by simply mixing solid-electrolyte raw materials and a complexing agent, the solid-electrolyte raw materials contained in the raw material-containing substance and the complexing agent can be mixed to form a complex. The mixture of the raw materials and the complexing agent may be ground with a grinder for reducing the mixing time for providing the complex or refining the powder, but, as described above, a grinder is preferably not used.

An example of an apparatus for mixing the solid-electrolyte raw materials and the complexing agent is a mechanical stirring mixer having a stirring blade in a vessel. Examples of the mechanical stirring mixer include a high-speed stirring mixer and a double-arm mixer, and from the viewpoints of increasing uniformity of the solid-electrolyte raw materials in the mixture of the solid-electrolyte raw materials and the complexing agent and attaining a higher ionic conductivity, a high-speed stirring mixer is preferably used. Examples of the high-speed stirring mixer include a vertical axis rotating mixer and a horizontal axis rotating mixer, and either type of a mixer may be used.

Examples of the shape of the stirring blade used in the mechanical stirring mixer include an anchor shape, a blade shape, an arm shape, a ribbon shape, a multistage blade shape, a dual arm shape, a shovel shape, a twin screw blade shape, a flat blade shape, and a C-blade shape. From the viewpoint of increasing the uniformity of the solid-electrolyte raw material to attain a higher ionic conductivity, a shovel shape, a flat blade shape, or a C-blade shape is preferred. In the mechanical stirring mixer, it is preferred to introduce a circulation line in which the substance to be stirred is once discharged outside the mixer and is returned again inside the mixer. Thus, a raw material having a high specific gravity, such as a lithium halide, is stirred without being settled or retained, whereby more uniform mixing can be applied.

The installation position of the circulation line is not particularly limited, but the circulation line is preferably placed at such a position that the substance is discharged from the bottom of the mixer and is returned into the upper part of the mixer. Thus, a solid-electrolyte raw material that is liable to settle is more easily uniformly stirred by allowing it to ride on the convective flow by circulation. Furthermore, a return port is preferably positioned below the liquid surface of the substance to be stirred. Thus, the liquid substance to be stirred can be prevented from splashing to attach the inner wall surface of the mixer.

The temperature condition in mixing the solid-electrolyte raw materials and the complexing agent is not particularly limited, and is, for example, −30 to 100° C., preferably −10 to 50° C., and more preferably about a room temperature (23° C.) (for example, room temperature ±5° C.). The mixing time is about 0.1 to 150 hours, and from the viewpoint of more uniformly mixing to attain a higher ionic conductivity, is preferably 1 to 120 hours, more preferably 4 to 100 hours, and further preferably 8 to 80 hours.

By mixing solid-electrolyte raw materials and a complexing agent, a complex is formed with the solid-electrolyte raw materials and the complexing agent. More specifically, in the complex, by the action of the complexing agent and a lithium atom, a sulfur atom, a phosphorus atom, and a halogen atom contained in the solid-electrolyte raw materials, the atoms bind to each other via the complexing agent and/or directly bind without intermediation of the complexing agent. In other words, in the method (ii) for providing a reaction product, a complex obtained by mixing solid-electrolyte raw materials and a complexing agent is composed of the complexing agent, a lithium atom, a sulfur atom, a phosphorus atom, and a halogen atom.

Since the complex obtained in the method (ii) for providing a reaction product is not completely dissolved in the complexing agent which is liquid, and is generally solid, a suspension is obtained in which the complex is suspended in the complex and a solvent which is added as needed. Accordingly, the method (ii) for providing a reaction product corresponds to a so-called heterogeneous system in a liquid phase method.

### (Solvent)

In the method (ii) for providing a reaction product, in mixing solid-electrolyte raw materials and a complexing agent, a solvent may be further added.

In forming a complex as a solid in a complexing agent as a liquid, when the complex is easily dissolved in the complexing agent, separation of components may occur. Thus, by using a solvent that does not dissolve the complex, elution of a component in the complex can be suppressed. In addition, by mixing solid-electrolyte raw materials and a complexing agent using a solvent, formation of a complex is promoted and each main component can exist more uniformly, resulting in a complex in which the dispersion state of the solid-electrolyte raw materials, in particular, the dispersion state of the halogen atom is kept uniform. As a result, an effect to achieve a high ionic conductivity is more easily exhibited.

The method (ii) for providing a reaction product is a so-called heterogeneous method, and the complex is preferably not completely dissolved in the complexing agent which is a liquid to precipitate. By adding a solvent, the solubility of the complex can be adjusted. In particular, since a halogen atom tends to be eluted from a complex, by adding a solvent, elution of a halogen atom can be suppressed to provide a desired complex. As a result, a sulfide solid electrolyte having a high ionic conductivity is more easily obtained through a complex in which a component of a solid-electrolyte raw material, in particular, a solid-electrolyte raw material containing a halogen atom is uniformly dispersed.

A preferred example of the solvent having such a property is a solvent having a solubility parameter of 10 or less. In the description herein, the solubility parameter is a value δ ((cal/cm³)^{1/2}) which is described in various documents, for example, “Kagaku Binran” (published in 2004, revised 5th edition, Maruzen Co., Ltd.) and the like and which is calculated by the following expression (1), and the solubility parameter is also referred to as Hildebrand Parameter or SP value.

δ=\sqrt{(ΔH−RT)/V} (1)

(In the expression (1), ΔH is the molar calorific value, R is the gas constant, T is the temperature, and V is the molar volume.)

By using a solvent having a solubility parameter of 10 or less, it is possible to allow a solid-electrolyte raw material, in particular, a halogen atom, a raw material containing a halogen atom, such as lithium halide, furthermore, a component containing a halogen atom constituting a complex (for example, an aggregate in which lithium halide and a complexing agent bind) and the like, to be relatively less likely to dissolve therein as compared with the complexing agent. Thus, it becomes easy to fix, in particular, a halogen atom in the complex, and the halogen atom exists in a good dispersion state in the resulting sulfide solid electrolyte, thereby more easily providing a sulfide solid electrolyte having a high ionic conductivity. In other words, the solvent used in the method (ii) for providing a reaction product preferably has such a property that the complex is not dissolved therein. From the same point of view, the solubility parameter of the solvent is preferably 9.5 or less, more preferably 9.0 or less, and further preferably 8.5 or less.

As the solvent used in this embodiment, more specifically, a solvent that has been conventionally used in production of a solid electrolyte can be widely used, and examples thereof include solvents containing a carbon atom, for example, hydrocarbon solvents, such as an aliphatic hydrocarbon solvent, an alicyclic hydrocarbon solvent, and an aromatic hydrocarbon solvent; an alcohol solvent, an ester solvent, an aldehyde solvent, a ketone solvent, an ether solvent in which the number of carbon atoms on one side is 4 or more, and a solvent containing a carbon atom and a heteroatom. Among them, a solvent having a solubility parameter in the above range may be preferably appropriately selected and used.

More specific examples thereof include aliphatic hydrocarbon solvents, such as hexane (7.3), pentane (7.0), 2-ethylhexane, heptane (7.4), octane (7.5), decane, undecane, dodecane, and tridecane; alicyclic hydrocarbon solvents, such as cyclohexane (8.2) and methylcyclohexane; aromatic hydrocarbon solvents, such as benzene, toluene (8.8), xylene (8.8), mesitylene, ethylbenzene (8.8), tert-butylbenzene, trifluoromethylbenzene, nitrobenzene, chlorobenzene (9.5), chlorotoluene (8.8), and bromobenzene; alcohol solvents, such as ethanol (12.7) and butanol (11.4); aldehyde solvents, such as formaldehyde, acetaldehyde (10.3), and dimethylformamide (12.1); ketone solvents, such as acetone (9.9) and methyl ethyl ketone; ether solvents, such as dibutyl ether, cyclopentyl methyl ether (8.4), tert-butyl methyl ether, and anisole; and solvents containing a carbon atom and a heteroatom, such as acetonitrile (11.9), dimethylsulfoxide, and carbon disulfide. The numerical values in the parentheses show the SP values.

The examples mentioned above are just an example, and, for example, a compound having isomers can encompasses all the isomers. Any solvent that is substituted with a halogen atom, and any alicyclic hydrocarbon solvent and any aromatic hydrocarbon solvent that are substituted with, for example, an aliphatic group, such as an alkyl group, can also be encompassed.

Among such solvents, an aliphatic hydrocarbon solvent, an alicyclic hydrocarbon solvent, an aromatic hydrocarbon solvent, or an ether solvent is preferred, and from the viewpoint of more stably attaining a high ionic conductivity, heptane, cyclohexane, toluene, ethylbenzene, diethyl ether, diisopropyl ether, dibutyl ether, dimethoxyethane, cyclopentyl methyl ether, tert-butyl methyl ether, or anisole is more preferred, diethyl ether, diisopropyl ether, or dibutyl ether is further preferred, diisopropyl ether or dibutyl ether is furthermore preferred, and cyclohexane is particularly preferred.

The solvent used in the method (ii) for providing a reaction product is preferably an organic solvent as mentioned above that is different from the complexing agent. In the method (ii) for providing a reaction product, one of the solvents may be used alone or two or more thereof may be used in combination.

### (Heating to Provide a Complex Degradation Product)

The method (ii) for providing a reaction product includes heating the complex obtained by the mixing to provide a complex degradation product. The complex degradation product is obtained, from the complex obtained by the mixing, by removing the complexing agent by heating, and, as described above, can be referred to as an amorphous sulfide solid electrolyte.

A complex is formed from solid-electrolyte raw materials and a complexing agent, and by forming the complex, the solid-electrolyte raw materials exist in tight contact at the molecular level. Thus, it is considered that, when the complexing agent is removed by heating, the solid-electrolyte raw materials in tight contact bind to each other to form a sulfide solid electrolyte.

The temperature in heating the complex in the method (ii) for providing a reaction product is not particularly limited as long as it is a temperature to provide the reaction product, that is, a temperature at which an amorphous sulfide solid electrolyte can be obtained, and, for example, the temperature in heating can be determined in the structure of the crystalline sulfide solid electrolyte obtained by heating the reaction product (amorphous sulfide solid electrolyte).

More specifically, the heating temperature is preferably, in a differential thermal analysis (DTA) of the reaction product (amorphous sulfide solid electrolyte) under a temperature rise condition of 10° C./min with a differential thermal analysis instrument (DTA instrument), based on the peak top temperature of the exothermic peak observed on the lowest temperature side, a temperature in the range of preferably 5° C. or lower, more preferably 10° C. or lower, and further preferably 20° C. or lower, and the lower limit is not particularly limited, but may be about a temperature of the peak top temperature of the exothermic peak observed on the lowest temperature side minus 40° C. or higher. With a temperature in such a range, a reaction product (amorphous sulfide solid electrolyte) can be more efficiently and securely obtained.

The heating temperature for providing a reaction product (amorphous sulfide solid electrolyte) cannot be completely specified since it depends on the structure of the resulting crystalline sulfide solid electrolyte, but, in general, is preferably 135° C. or lower, more preferably 130° C. or lower, and further preferably 125° C. or lower, and the lower limit is not particularly limited, but is preferably 90° C. or higher, more preferably 100° C. or higher, and further preferably 110° C. or higher.

The heating time in the method (ii) for providing a reaction product is not particularly limited as long as it is a time in which a desired reaction product (amorphous sulfide solid electrolyte) can be obtained, and, for example, is preferably 1 minute or more, more preferably 10 minutes or more, further preferably 30 minutes or more, and furthermore preferably 1 hour or more. The upper limit of the heating time is not particularly limited, but is preferably 24 hours or less, more preferably 10 hours or less, further preferably 5 hours or less, and furthermore preferably 3 hours or less.

The heating in the method (ii) for providing a reaction product is preferably performed under an inert gas atmosphere (for example, nitrogen atmosphere, argon atmosphere), or under a decompression atmosphere (particularly in vacuum). This is because degradation of the crystalline sulfide solid electrolyte (for example, oxidation) can be prevented.

The heating method is not particularly limited, and, examples thereof include methods using a hot plate, a vacuum heating apparatus, an argon gas atmosphere furnace, and a baking furnace. In the industry, a horizontal dryer or horizontal vibration fluid dryer including a heating means and a feeding mechanism, or the like can also be used, and the method may be selected according to the amount to be heated.

### (Drying)

In the method (ii) for providing a reaction product, while a complex can be obtained by mixing the solid-electrolyte raw materials and the complexing agent, the complexing agent that does not contribute to the formation of the complex and remains, and a solvent, if used, also exist. In other words, in the method (ii), a mixture obtained by mixing the solid-electrolyte raw materials and the complexing agent is a substance containing the complex, the remaining complexing agent, a solvent which is used as needed, and the like (hereinafter sometimes referred to as “complex-containing substance”). Thus, drying may be included for removing the remaining complexing agent and the solvent by drying, before heating, the complex-containing substance obtained by the mixing. Thus, a powder of the complex is obtained.

By drying in advance, efficient heating can be performed. Drying and the subsequent heating may be performed in one step.

Drying of the complex-containing substance can be performed at a temperature according to the types of the remaining complexing agent (the complexing agent that is not taken in the complex) and the solvent which is used as needed. Specifically, drying can be performed at a temperature of the boiling points of the complexing agent and the solvent or higher.

The specific drying conditions cannot be completely specified since they depends on the types of the complexing agent and the solvent, but in general, drying can be performed by volatilizing the complexing agent and the solvent at a temperature of 5 to 100° C., preferably 10 to 85° C., more preferably 15 to 70° C., furthermore preferably about a room temperature (23° C.) (for example, about a room temperature ±5° C.) by decompression drying (vacuum drying) with a vacuum pump or the like.

Drying of the complex-containing substance may be performed through solid-liquid separation by filtration using a glass filter or by decantation, or through solid-liquid separation using a centrifuge. For example, after solid-liquid separation, drying under the above temperature condition may be performed.

Specifically, the solid-liquid separation is easily achieved by decantation in which after the complex is precipitated in the complex-containing substance transferred into a container, the complexing agent and the solvent as the supernatant is removed, or filtration, for example, using a glass filter having a pore size of about 10 to 200 μm, preferably 20 to 150 μm.

Although drying was described as a treatment in the method (ii) for providing a reaction product, drying may be performed for removing a solvent, for example, when mixing with a grinder is performed with a solvent in the method (i) for providing a reaction product.

### (Reaction Product)

The reaction product resulting from the providing a reaction product is an amorphous sulfide solid electrolyte.

The reaction product as an amorphous solid electrolyte contains a lithium atom, a sulfur atom, a phosphorus atom, and a halogen atom, and typical preferred examples thereof include a solid electrolyte composed of lithium sulfide, phosphorus sulfide, and lithium halide, such as Li₂S—P₂S₅—LiI, Li₂S—P₂S₅—LiCl, Li₂S—P₂S₅—LiBr, or Li₂S—P₂S₅—LiI—LiBr; and a solid electrolyte containing another atom, such as an oxygen atom or a silicon atom, such as Li₂S—P₂S₅—Li₂O—LiI, or Li₂S—SiS₂—P₂S₅—LiI. From the viewpoint of attaining a higher ionic conductivity, a solid electrolyte composed of lithium sulfide, phosphorus sulfide, and lithium halide, such as Li₂S—P₂S₅—LiI, Li₂S—P₂S₅—LiCl, Li₂S—P₂S₅—LiBr, or Li₂S—P₂S₅—LiI—LiBr, is preferably exemplified.

The kinds of the atoms constituting the amorphous solid electrolyte can be found, for example, by ICP emission spectrophotometer.

When the reaction product as an amorphous solid electrolyte contains at least Li₂S—P₂S₅, the molar ratio of Li₂S and P₂S₅ is, from the viewpoint of attaining a higher ionic conductivity, preferably 65 to 85:15 to 35, more preferably 70 to 80:20 to 30, and further preferably 72 to 78:22 to 28.

When the reaction product as an amorphous solid electrolyte is, for example, Li₂S—P₂S₅—LiI—LiBr, the total content of lithium sulfide and diphosphorus pentasulfide is preferably 60 to 95% by mole, more preferably 65 to 90% by mole, and further preferably 70 to 85% by mole. The proportion of lithium bromide based on the sum of lithium bromide and lithium iodide is preferably 1 to 99% by mole, more preferably 20 to 90% by mole, further preferably 40 to 80% by mole, and particularly preferably 50 to 70% by mole.

In the reaction product as an amorphous solid electrolyte, the ratio (by mole) of the lithium atoms, sulfur atoms, phosphorus atoms, and halogen atoms blended is preferably 1.0 to 1.8:1.0 to 2.0:0.1 to 0.8:0.01 to 0.6, more preferably 1.1 to 1.7:1.2 to 1.8:0.2 to 0.6:0.05 to 0.5, and further preferably 1.2 to 1.6:1.3 to 1.7:0.25 to 0.5:0.08 to 0.4. When bromine and iodine are used in combination as halogen atoms, the ratio (by mole) of lithium atoms, sulfur atoms, phosphorus atoms, bromine, and iodine blended is preferably 1.0 to 1.8:1.0 to 2.0:0.1 to 0.8:0.01 to 0.3:0.01 to 0.3, more preferably 1.1 to 1.7:1.2 to 1.8:0.2 to 0.6:0.02 to 0.25:0.02 to 0.25, more preferably 1.2 to 1.6:1.3 to 1.7:0.25 to 0.5:0.03 to 0.2:0.03 to 0.2, and further preferably 1.35 to 1.45:1.4 to 1.7:0.3 to 0.45:0.04 to 0.18:0.04 to 0.18. With a ratio (by mole) of lithium atoms, sulfur atoms, phosphorus atoms, and halogen atoms blended within the above range, a crystalline solid electrolyte having a thio-LISICON Region II-type crystal structure as described later and having a higher ionic conductivity is more easily obtained. The blending ratio (by mole) in a crystalline product (crystalline solid electrolyte) as described later is within the above range of the blending ratio (by mole) in the reaction product which is an amorphous solid electrolyte, and when the reaction product is heated to provide the crystalline product, the blending ratios (by mole) in the reaction product and in the crystalline product are the same as each other.

### [Heating to Provide a Crystalline Product]

The production method of this embodiment includes, following the providing a reaction product, heating the resulting reaction product to provide a crystalline product. By heating the reaction product, crystallization of the reaction product proceeds, whereby a crystalline product is provided.

The heating temperature is not particularly limited as long as crystallization of the reaction product is promoted to provide a crystalline product. For example, the heating temperature is determined according to the structure of the crystalline product obtained by hating the reaction product. Specifically, the heating temperature is preferably, in a differential thermal analysis (DTA) of the reaction product under a temperature rise condition of 10° C./min with a differential thermal analysis instrument (DTA instrument), based on the peak top temperature of the exothermic peak observed on the lowest temperature side, a temperature in the range of preferably 5° C. or higher, more preferably 10° C. or higher, and further preferably 20° C. or higher, and the upper limit is not particularly limited, but may be about 40° C. or lower. With a temperature within the range, not only crystallization of the reaction product is more efficiently and securely promoted to provide a crystalline product, but also the contents of the complexing agent remaining in the crystalline product and the solvent which is used as needed can be reduced and the content of the reaction product can be reduced to increase the purity of the crystalline product. As a result, the purity of the crystalline sulfide solid electrolyte obtained by the production method of this embodiment can be increased.

The heating temperature cannot be completely specified since it depends on the structure of the resulting crystalline product, but, in general, is preferably 130° C. or higher, more preferably 140° C. or higher, and further preferably 150° C. or higher, and the upper limit is not particularly limited, but is preferably 300° C. or lower, more preferably 280° C. or lower, and further preferably 250° C. or lower.

The heating time is not particularly limited as long as a desired crystalline product is provided, but, for example, preferably 1 minute or more, 10 minutes or more, further preferably 30 minutes or more, and furthermore preferably 1 hour or more. The upper limit of the heating time is not particularly limited, but is preferably 24 hours or less, more preferably 10 hours or less, further preferably 5 hours or less, and furthermore preferably 3 hours or less.

In heating to provide a crystalline product, the heating can be performed at a normal pressure, but can also be performed under a decompression atmosphere or under a vacuum atmosphere in order to decrease the heating temperature.

In heating under a decompression atmosphere, the pressure condition is preferably 85 kPa or less, more preferably 80 kPa or less, and further preferably 70 kPa or less, and the lower limit may be vacuum (0 Kpa), and in view of easy control of the pressure, is preferably 1 kPa or more, more preferably 2 kPa or more, and further preferably 3 kPa or more. When the pressure condition is within the above range, the heating condition can be mild to suppress an increase in the scale of the equipment.

The heating is preferably performed under an inert gas atmosphere (for example, a nitrogen atmosphere, an argon atmosphere). This is because degradation of the crystalline product (for example, oxidation) can thus be prevented.

The heating method is not particularly limited, and examples thereof include methods using a hot plate, a vacuum heating apparatus, an argon gas atmosphere furnace, and a baking furnace. In the industry, a horizontal dryer or a horizontal vibration fluid dryer including a heating means and a feeding mechanism, or the like can also be used, and the method may be selected according to the amount to be heated.

When the method (ii) for providing a reaction product is adopted, a complex is heated to provide a complex degradation product. Heating may be further applied, following the heating for providing the complex degradation product, to thereby convert the complex degradation product (that is, the reaction product) to a crystalline product. Also in this case, since the crystalline product is produced from a complex via a complex degradation product (reaction product), it can be said that the crystalline product is obtained through the providing a reaction product and the heating the reaction product to provide a crystalline product as described above.

### (Crystalline Product)

The crystalline product obtained by heating the reaction product can be considered as a crystalline sulfide solid electrolyte having a crystal structure. The crystalline sulfide solid electrolyte obtained by the production method of this embodiment is obtained by subjecting a crystalline product to a grinding treatment with a specific integrated power, and has a crystal structure that the crystalline product has. Accordingly, the crystal structure described below as a crystal structure that the crystalline product has is also a crystal structure that the crystalline sulfide solid electrolyte obtained by the production method of this embodiment has.

Examples of the crystal structure that the crystalline product has include an Li₃PS₄ crystal structure, an Li₄P₂S₆ crystal structure, an Li₇PS₆ crystal structure, an Li₇P₃S₁₁ crystal structure, a crystal structure having peaks at 2θ=around 20.2° and around 23.6° (for example, JP 2013-16423 A).

Examples of the crystal structure that the crystalline product has also include an Li₄₋ₓGe₁₋ₓPₓS₄-based thio-LISICON Region II (thio-LISICON Region II)-type crystal structure (see, Kanno et. al., Journal of The Electrochemical Society, 148(7)A742-746 (2001)), a crystal structure similar to the Li₄₋ₓGe₁₋ₓPₓS₄-based thio-LISICON Region II (thio-LISICON Region II)-type (see, Solid State Ionics, 177 (2006), 2721-2725).

In terms of achieving a higher ionic conductivity, the crystal structure that the crystalline product has is preferably a thio-LISICON Region II-type crystal structure. Here, the “thio-LISICON Region II-type crystal structure” means either of an Li₄₋ₓGe₁₋ₓPₓS₄-based thio-LISICON Region II (thio-LISICON Region II)-type crystal structure or a crystal structure similar to the Li₄₋ₓGe₁₋ₓPₓS₄-based thio-LISICON Region II (thio-LISICON Region II)-type.

The crystalline product may contain the thio-LISICON Region II-type crystal structure or may contain the structure as a main crystal, but, from the viewpoint of attaining a higher ionic conductivity, preferably contains the structure as a main crystal. In the description herein, “containing as a main crystal” means that the proportion of the subject crystal structure in the crystal structure is 80% or more, and the proportion is preferably 90% or more, and more preferably 95% or more. From the viewpoint of attaining a higher ionic conductivity, the crystalline product preferably contains no crystalline Li₃PS₄ (β-Li₃PS₄).

In X-ray diffractometry using the CuKα line, the diffraction peaks of the Li₃PS₄ crystal structure appear, for example, at around 2θ=17.5°, 18.3°, 26.1°, 27.3°, and 30.0°, the diffraction peaks of the Li₄P₂S₆ crystal structure appear, for example, at around 2θ=16.9°, 27.1°, and 32.5°, the diffraction peaks of the Li₇PS₆ crystal structure appear, for example, at around 2θ=15.3°, 25.2°, 29.6°, and 31.0°, and the diffraction peaks of the Li₇P₃S₁₁ crystal structure appear, for example, at around 2θ=17.8°, 18.5°, 19.7°, 21.8°, 23.7°, 25.9°, 29.6°, and 30.0°. The diffraction peaks of the Li₄₋ₓGe₁₋ₓPₓS₄-based thio-LISICON Region II (thio-LISICON Region II)-type crystal structure appear, for example, at around 2θ=20.1°, 23.9°, and 29.5°, the diffraction peaks of the crystal structure similar to the Li₄₋ₓGe₁₋ₓPₓS₄-based thio-LISICON Region II (thio-LISICON Region II)-type appear, for example, at around 2θ=20.2° and 23.6°. The positions of the peaks may vary within the range of ±0.5°.

A preferred example of the crystal structure that the crystalline product has is an argyrodite-type crystal structure having an Li₇PS₆ structural backbone in which P is partially substituted with Si.

Examples of the compositional formula of the argyrodite-type crystal structure include crystal structures represented by a compositional formula Li₇₋ₓ P_{1-y}Si_{y}S₆ and Li₇₊ₓP_{1-y}Si_{y}S₆ (x is −0.6 to 0.6, y is 0.1 to 0.6). The argyrodite-type crystal structure represented by the compositional formula is a cubic crystal or an orthorhombic crystal, preferably a cubic crystal, and has peaks mainly appearing at positions of 2θ=15.5°, 18.0°, 25.0°, 30.0°, 31.4°, 45.3°, 47.0°, and 52.0° in X-ray diffractometry using the CuKα line.

Another example of the compositional formula of the argyrodite-type crystal structure is a compositional formula Li_{7-x-2y}PS_{6-x-y}Clₓ (0.8≤x≤1.7, 0<y≤−0.25x+0.5). The argyrodite-type crystal structure represented by the compositional formula is preferably a cubic crystal and has peaks mainly appearing at position of 2θ=15.5°, 18.0°, 25.0°, 30.0°, 31.4°, 45.3°, 47.0°, and 52.0° in X-ray diffractometry using the CuKα line.

Another example of the compositional formula of the argyrodite-type crystal structure is a compositional formula Li₇₋ₓPS₆₋ₓHaₓ (Ha is Cl or Br, x is preferably 0.2 to 1.8). The argyrodite-type crystal structure represented by the compositional formula is preferably a cubic crystal and has peaks mainly appearing at position of 2θ=15.5°, 18.0°, 25.0°, 30.0°, 31.4°, 45.3°, 47.0°, and 52.0° in X-ray diffractometry using the CuKα line.

The positions of the peaks may vary within the range of ±0.5°.

### [Amorphizing at Least a Part of the Surface of the Crystalline Product]

The production method of this embodiment includes subjecting the crystalline product obtained by heating to a grinding treatment to amorphize at least a part of the surface of the crystalline product. The grinding treatment requires an integrated power of 1 (Wh/kg) or more and 500 (Wh/kg) or less. As described above, by grinding the crystalline product with a specific integrated power, at least a part of the surface thereof can be amorphized.

### (Integrated Power)

In the production method of this embodiment, it is important that the integrated power in the grinding treatment is 1 (Wh/kg) or more and 500 (Wh/kg) or less. With an integrated power less than 1 (Wh/kg), amorphization is not sufficient and the characteristics of the amorphous sulfide solid electrolyte, that is, a superior oxidation resistance cannot be achieved. On the other hand, with an integrated power more than 500 (Wh/kg), amorphization is not confined in at least a part of the surface but the whole of the crystalline product is amorphized, thus failing to achieve a high ionic conductivity.

The integrated power in the production method of this embodiment can be determined as follows.

### (Determination of Integrated Power)

The integrated energy E (unit: Wh/kg) can be determined by the following expression, with the blank power average of each machine not containing the crystalline product (subject matter of the grinding treatment) being designated as P₀ (unit: W), an instant power average required in treating the crystalline product with the machine as P (unit: W), the total treatment time as t (unit: h), the total weight of the crystalline product treated as M (unit: kg).

E=(P−P₀)×t/M

From the viewpoint of increasing the oxidation resistance while attaining a high ionic conductivity, the integrated power of the grinding treatment is preferably 5 (Wh/kg) or more, more preferably 10 (Wh/kg) or more, and further preferably 25 (Wh/kg) or more, and as the upper limit, preferably 450 (Wh/kg) or less, more preferably 400 (Wh/kg) or less, and further preferably 350 (Wh/kg) or less. With an integrated power within the above range, it is also possible to suppress granulation, an increase in the specific surface area, and a significant reduction in the ionic conductivity.

### (Grinding Treatment)

The grinding treatment of the crystalline product may be performed using a machine capable of performing grinding, and is preferably performed using a grinder.

A preferred example of the grinder is the grinder described as a machine capable of performing mixing of solid-electrolyte raw materials in the method (i) for providing a reaction product. Among the grinders, since the integrated power is easily controlled and amorphization is easily promoted, a ball mill and a bead mill which are exemplified as a container-driven grinder are preferred, and among them, those of a planetary type are preferred.

When a ball mill or a bead mill is used, the size and material of beads or balls are the same as those described for the grinder that can be used in mixing solid-electrolyte raw materials.

The operation conditions when a ball mill or a bead mill is used, specifically, the rotation speed and the grinding time are not particularly limited as long as the integrated power is within the above range, and may be appropriately selected from the rotation speeds and grinding times described above for the grinder that can be used in mixing solid-electrolyte raw materials.

### (Crystalline Sulfide Solid Electrolyte)

The crystalline sulfide solid electrolyte obtained by the production method of this embodiment has an amorphized part as at least a part of the surface thereof.

In the production method of this embodiment, by controlling the types and use amounts of the solid-electrolyte raw materials contained in the raw material-containing substance, a crystalline sulfide solid electrolyte having a desired crystal structure can be obtained. The crystal structure that the crystalline sulfide solid electrolyte obtained by the production method of this embodiment has is, as described above, the same as the crystal structure that the crystalline product has, and examples thereof include the crystal structures described as a crystal structure that the crystalline product can have. Among them, a thio-LISICON Region II-type crystal structure is preferred since it has a high ionic conductivity.

The form of the crystalline solid electrolyte obtained by the production method of this embodiment is not particularly limited, and an example is a particle form.

The average particle diameter (D50) of the crystalline solid electrolyte in a particle form is, for example, 0.01 μm or more, furthermore 0.03 μm or more, 0.05 μm or more, and 0.1 μm or more, and as the upper limit, 5 μm or less, furthermore 3.0 μm or less, 1.5 μm or less, and 1.0 μm or less.

According to the production method of this embodiment, the average particle diameter of the crystalline sulfide solid electrolyte is small enough to be sufficiently used in the subsequent application (for example, electrode combined material, lithium ion battery) since granulation and an increase in the specific surface area can be suppressed.

The ionic conductivity of the crystalline solid electrolyte obtained by the production method of this embodiment is 1.5×10⁻³ S/cm or more, furthermore 1.7×10⁻³ S/cm or more, and 1.9×10⁻³ S/cm or more.

According to the production method of this embodiment, a significant reduction in the ionic conductivity can be suppressed, and thus, it can be said that the ionic conductivity of the crystalline sulfide solid electrolyte is high. Here, the ionic conductivity in the description herein is measured by a method described in the section of Examples.

The oxidation current of the crystalline solid electrolyte obtained by the production method of this embodiment is an oxidation current equivalent to that of the amorphous sulfide solid electrolyte, in other words, it is smaller than the oxidation current of the crystalline sulfide solid electrolyte, and thus, a superior oxidation resistance is achieved.

The reduction rate in the oxidation current of the crystalline solid electrolyte obtained by the production method of this embodiment is preferably 10% or more, more preferably 15% or more, further preferably 20% or more, and furthermore preferably 25% or more. Here, the reduction rate in the oxidation current is calculated by the following expression. In other words, the reduction rate in the oxidation current is a reduction rate from the oxidation current before amorphizing at least a part of the surface of the crystalline product to the oxidation current after amorphization.

Reduction rate in oxidation current (%)=(oxidation current 2−oxidation current 1)/oxidation current 2×100
oxidation current 1: the oxidation current of the crystalline sulfide solid electrolyte that has the amorphized part as at least a part of the surface (the oxidation current of the crystalline sulfide solid electrolyte obtained by amorphizing at least a part of the surface of the crystalline product) (mA)
oxidation current 2: the oxidation current of the crystalline sulfide solid electrolyte before providing the amorphized part as at least a part of the surface (the oxidation current of the crystalline product) (mA)

The oxidation current of the crystalline solid electrolyte obtained by the production method of this embodiment cannot not be completely specified since the absolute value depends on the measurement conditions, but when measured by a method for measuring oxidation current in the section of Examples described later, the oxidation current is preferably 0.45 mA or less, more preferably 0.40 mA or less, and further preferably 0.38 mA or less.

### [Crystalline Sulfide Solid Electrolyte]

The crystalline sulfide solid electrolyte of this embodiment is
a crystalline sulfide solid electrolyte containing a lithium atom, a sulfur atom, a phosphorus atom, and a halogen atom,
the crystalline sulfide solid electrolyte having an amorphized part as at least a part of the surface thereof.

The sulfide solid electrolyte of this embodiment can be produced by the production method of this embodiment, and from the viewpoint of more efficient production, is preferably produced by the production method of this embodiment. In other words, the crystalline sulfide solid electrolyte of this embodiment is a crystalline sulfide solid electrolyte that has a superior oxidation resistance, has a high ionic conductivity, and in which granulation and an increase in the specific surface area is suppressed.

The crystalline sulfide solid electrolyte of this embodiment contains a lithium atom, a phosphorus atom, a sulfur atom, and a halogen atom. The atoms are derived from solid-electrolyte raw materials contained in a raw material-containing substance used in the production method of this embodiment.

The crystalline sulfide solid electrolyte of this embodiment has an amorphized part as at least a part of the surface. Possession of the amorphized part and the aspect of the amorphized part are the same as those described for the crystalline sulfide solid electrolyte obtained by the production method of this embodiment.

Other properties, for example, the crystal structure that the crystalline sulfide solid electrolyte can have, the ionic conductivity, the average particle diameter, the oxidation current measured by a cyclic voltammetry measurement (CV measurement), and the reduction rate thereof are also the same as those described for the crystalline sulfide solid electrolyte obtained by the production method of this embodiment.

### (Application)

Since the crystalline sulfide solid electrolyte of this embodiment has a superior oxidation resistance while suppressing granulation, an increase in the specific surface area, and a significant reduction in the ionic conductivity, the crystalline sulfide solid electrolyte is suitably used for an electrode combined material, a lithium ion battery, and the like.

When used in a lithium ion battery, the crystalline sulfide solid electrolyte may be used in a positive electrode layer, a negative electrode layer, or an electrolyte layer, of the lithium ion battery. Each layer can be produced by a known method.

The lithium ion battery preferably uses a collector in addition to the positive electrode layer, the electrolyte layer, and the negative electrode layer, and as the collector, a known collector can be used. For example, a layer obtained by coating Au, Pt, Al, Ti, Cu, or the like, which reacts with the solid electrolyte, with Au or the like can be used.

### [Electrode Combined Material]

The electrode combined material of this embodiment uses the crystalline sulfide solid electrolyte of this embodiment, and contains the crystalline sulfide solid electrolyte of this embodiment and an electrode active substance.

### (Electrode Active Substance)

As the electrode active substance, either of a positive electrode active substance or a negative electrode active substance is adopted depending on which of a positive electrode or a negative electrode the electrode combined material is to be used in.

As the positive electrode active substance, depending on the relation with the negative electrode active substance, any one that can promote a battery chemical reaction associated with transfer of lithium ions, the reaction being caused by an atom to be adopted as an atom that develops the ionic conductivity, preferably a lithium atom, can be used with not particular limitation. Examples of such a positive electrode active substance that enables insertion and elimination of lithium ions include an oxide-based positive electrode active substance and a sulfide-based positive electrode active substance.

Preferred examples of the oxide-based positive electrode active substance include lithium-containing transition metal composite oxides, such as LMO (lithium manganese oxide), LCO (lithium cobalt oxide), NMC (lithium nickel manganese cobalt oxide), NCA (lithium nickel cobalt aluminum oxide), LNCO (lithium nickel cobalt oxide), and an olivine-type compound (LiMeNPO₄, Me=Fe, Co, Ni, Mn).

Examples of the sulfide-based positive electrode active substance include titanium sulfide (TiS₂), molybdenum sulfide (MoS₂), iron sulfide (FeS, FeS₂), copper sulfide (CuS), and nickel sulfide (Ni₃S₂).

In addition to the above positive electrode active substances, niobium selenide (NbSe₃) and the like can also be used.

One of the positive electrode active substances can be used alone or two or more thereof can be used in combination.

As the negative electrode active substance, any one that promotes a battery chemical reaction associated with transfer of lithium ions, the reaction preferably being caused by a lithium atom, of a metal that can form an alloy with an atom adopted as an atom that develops an ionic conductivity, preferably a lithium atom, an oxide of the metal, an alloy of the metal with a lithium atom, or the like, can be used with no particular limitation. As such a negative electrode active substance that allows for insertion and elimination of lithium ions, any one that is known as a negative electrode active substance in the field of battery can be adopted with no limitation.

Examples of the negative electrode active substance include metallic lithium or a metal that can form an alloy with metallic lithium, such as metallic lithium, metallic indium, metallic aluminum, metallic silicon, or metallic tin, an oxide of such a metal, and an alloy of such a metal with metallic lithium.

The electrode active substance may have a coating layer, the surface of the electrode active substance being coated with the coating layer.

As a material that forms the coating layer, an atom that develops an ionic conductivity in the crystalline sulfide solid electrolyte, preferably an ion conductor, such as a nitride or an oxide of a lithium atom, or a composite thereof is exemplified. Specific examples thereof include a conductor that has lithium nitride (Li₃N) or Li₄GeO₄ as a main structure, for example, a conductor having a LISICON-type crystal structure, such as Li₄₋₂ₓZnₓGeO₄, a conductor having a Li₃PO₄-type backbone structure, for example, a conductor having a thio-LISICON-type crystal structure, such as Li₄₋ₓGe₁₋ₓPₓS₄, a conductor having a perovskite-type crystal structure, such as La_{2/3-x}Li₃ₓTiO₃, and a conductor having a NASICON-type crystal structure, such as LiTi₂(PO₄)₃.

Examples thereof also include lithium titanates, such as Li_{y}Ti_{3-y}O₄ (0<y<3) and Li₄Ti₅O₁₂ (LTO), lithium metal oxides of a metal belonging to Group V in the periodic table, such as LiNbO₃ and LiTaO₃, and oxide-based conductors, such as a Li₂O—B₂O₃—P₂O₅-based, Li₂O—B₂O₃—ZnO-based, and Li₂O—Al₂O₃— SiO₂—P₂O₅—TiO₂-based conductor.

The electrode active substance having a coating layer is, for example, obtained by depositing a solution containing various atoms constituting a material to form the coating layer on the surface of an electrode active substance, and baking the electrode active substance after deposition preferably at 200° C. or higher and 400° C. or lower.

Here, as the solution containing various atoms, for example, a solution containing an alkoxide of various metals, such as lithium ethoxide, titanium isopropoxide, niobium isopropoxide, or tantalum isopropoxide, may be used. In this case, as a solvent, an alcohol solvent, such as ethanol or butanol, an aliphatic hydrocarbon solvent, such as hexane, heptane, or octane; or an aromatic hydrocarbon solvent, such as benzene, toluene, or xylene may be used.

The deposition may be performed by immersion, spray coating, or the like.

The baking temperature is, from the viewpoint of enhancing the production efficiency and battery performance, preferably 200° C. or higher and 400° C. or lower as described above, and more preferably 250° C. or higher and 390° C. or lower. The baking time is generally about 1 minute to 10 hours, and preferably 10 minutes to 4 hours.

The coating rate with the coating layer is, based on the surface area of the electrode active substance, preferably 90% or more, more preferably 95% or more, and further preferably 100%, that is, the whole surface is preferably coated. The thickness of the coating layer is preferably 1 nm or more, and more preferably 2 nm or more, and as the upper limit, preferably 30 nm or less, and more preferably 25 nm or less.

The thickness of the coating layer can be measured by sectional observation with a transmission electron microscope (TEM), and the coating rate can be calculated from the thickness of the coating layer, the elemental analysis value, and the BET specific surface area.

### (Other Components)

The electrode combined material of this embodiment may contain, besides the crystalline sulfide solid electrolyte and the electrode active substance, other components, such as an electric conductive material and a binder. In other words, in the electrode combined material of this embodiment, besides the sulfide solid electrolyte and the electrode active substance, other components, such as an electric conductive material and a binder, may be used. The other components, such as conductive agent and a binder, may be used, in mixing the sulfide solid electrolyte and the electrode active substance, by further adding the other components to the sulfide solid electrolyte and the electrode active substance and mixing them.

Examples of the electric conductive material include, from the viewpoint of increasing the electron conductivity to thus enhance the battery performance, carbon-based materials, such as artificial graphite, graphite carbon fiber, resin baked carbon, pyrolytic vapor-grown carbon, coke, meso-carbon microbeads, furfuryl alcohol resin baked carbon, polyacene, pitch-based carbon fiber, vapor grown carbon fiber, natural graphite, and hardly graphizable carbon.

By using a binder, when a positive electrode or a negative electrode is produced, the strength thereof is increased.

The binder is not particularly limited as long as it can impart functions, such as a binding property and flexibility, and examples thereof include fluorine-based polymers, such as polytetrafluoroethylene and polyvinylidene fluoride, thermoplastic elastomers, such as butylene rubber and styrene-butadiene rubber, and various resins, such as an acrylic resin, an acrylic polyol resin, a polyvinyl acetal resin, a polyvinyl butyral resin, and a silicone resin.

The blending ratio (by mass) of the electrode active substance and the sulfide solid electrolyte in the electrode combined material is, in view of enhancing the battery performance and of the production efficiency, preferably 99.5:0.5 to 40:60, more preferably 99:1 to 50:50, and further preferably 98:2 to 60:40.

When an electric conductive material is contained, the content of the electric conductive material in the electrode combined material is not particularly limited, but, in view of enhancing the battery performance and of the production efficiency, is preferably 0.5% by mass or more, more preferably 1% by mass or more, and further preferably 1.5% by mass or more, and as the upper limit, preferably 10% by mass or less, preferably 8% by mass or less, and further preferably 5% by mass or less.

When a binder is contained, the content of the binder in the electrode combined material is not particularly limited, but, in view of enhancing the battery performance and of the production efficiency, is preferably 1% by mass or more, more preferably 3% by mass or more, and further preferably 5% by mass or more, and as the upper limit, preferably 20% by mass or less, preferably 15% by mass or less, and further preferably 10% by mass or less.

### [Lithium Ion Battery]

The lithium ion battery of this embodiment is a lithium ion battery that contains at least one selected from the crystalline sulfide solid electrolyte of this embodiment and the electrode combined material.

The configuration of the lithium ion battery of this embodiment is not particularly limited as long as the lithium ion battery contains the sulfide solid electrolyte of this embodiment or an electrode combined material containing the sulfide solid electrolyte, and any lithium ion battery having a generally used configuration of a lithium ion battery may be used.

The lithium ion battery of this embodiment preferably includes, for example, a positive electrode layer, a negative electrode layer, an electrolyte layer, and a collector. The positive electrode layer and the negative electrode layer are preferably a positive electrode layer and a negative electrode layer in which an electrode combined material using the crystalline sulfide solid electrolyte of this embodiment is used. The electrolyte layer is preferably an electrolyte layer in which the crystalline sulfide solid electrolyte of this embodiment is used.

As the collector, a known collector may be used. For example, a layer obtained by coating Au, Pt, Al, Ti, Cu, or the like, which reacts with the solid electrolyte, with Au or the like can be used.

### EXAMPLES

Next, the present invention will be specifically described with reference to examples, but the present invention is no way limited to the examples.

### (Measurement of Powder XRD Diffraction)

The powder X-ray diffraction (XRD) was measured as follows.

A powder of each sulfide solid electrolyte obtained in Example and Comparative Example was filled in a groove having a diameter of 20 mm and a depth of 0.2 mm and was smoothened with glass to produce a specimen. This specimen was sealed with an XRD Kapton film and was measured under the following conditions without being exposed to the air.

Measurement apparatus: D2 PHASER, manufactured by Bruker Corporation

Tube voltage: 30 kV

Tube current: 10 mA

X-ray wavelength: Cu-Kα line (1.5418 Å)

Optical system: focusing

Slit structure: soller slit 4°, divergence slit 1 mm, Kβ filter (Ni plate)

Detector: semiconductor detector

Measurement region: 2θ=10-60 deg

Step width, scan speed: 0.05 deg, 0.05 deg/sec

### (Measurement of Ionic Conductivity)

In Example, the ionic conductivity was measured as follows.

Each crystalline solid electrolyte obtained in Example and Comparative Examples was molded into a circular palette having a diameter of 10 mm (sectional area S: 0.785 cm²) and a height (L) of 0.1 to 0.3 cm to produce a specimen. Electrode terminals were attached to the specimen from above and below, and measurement was performed by an alternating current impedance method at 25° C. (frequency range: 5 MHz to 0.5 Hz, amplitude: 10 mV) to provide a Cole-Cole plot. The real part Z′ (Ω) at the point at which —Z″ (Ω) became the minimum near the right end of an arc observed in a region on the high frequency side was designated as the bulk resistance R (Ω) of the electrolyte, and the ionic conductivity σ (S/cm) was calculated according to the following expressions.

R=ρ(L/S)

σ=1/ρ

### (Measurement of Average Particle Diameter)

The particle diameter distribution was obtained through measurement using a laser diffraction/scattering particle diameter distribution analyzer (“Partica LA-950 (model number)” manufactured by HORIBA, Ltd.). A cumulative curve of the obtained particle diameter distribution was drawn, and the particle diameter at which the cumulative amount from the side of the particle having the minimum particle diameter reaches 50% (by volume) of the total was read as the average particle diameter (D₅₀).

### (CV Measurement (Oxidation Current))

For evaluating the oxidation current, the following CV measurement cell was used.

Using a mortar, a powder obtained in Example and particulate Denka Black (particle diameter: 35 nm, manufactured by Denka Co., Ltd.) in an amount of 100 mg in total (powder:Denka Black (mass ratio)=85:15) were mixed for 10 minutes to provide a measurement powder (1).

In a battery cell having a diameter of 10 mm, 100 mg of an electrolyte for separator layer was added, and was pressed with a SUS mold at 10 MPa/cm² three times while rotating it by 120° each. Then, 10 mg of the measurement powder (1) was added thereto, and was pressed at 20 MPa/cm² three times while rotating it by 120° each. Then, the measurement powder (1) was pressed at 20 MPa/cm² three times from the opposite side while rotating it by 120° each.

The electrolyte for separator was synthesized under the following conditions.

Into a 1-L reaction vessel with a stirring blade, under a nitrogen atmosphere, 20.5 g of Li₂S, 33.1 g of P₂S₅, 10.0 g of LiI, and 6.5 g of LiBr were added. After rotating the stirring blade, 630 g of toluene was introduced, and this slurry was stirred for 10 minutes. The reaction vessel was connected to a bead mill capable of performing a cycle operation (“STRMILL LMZ015 (trade name)” manufactured by Ashizawa Finetech Ltd., material of beads: zirconia, diameter of beads: 0.5 mmφ, amount of beads: 456 g), and a grinding treatment (pump flow rate: 650 mL/min, bead mill peripheral speed: 12 m/s, mill jacket temperature: 45° C.) was performed for 45 hours.

The resulting slurry was dried in vacuum at a room temperature (25° C.), and then, was heated (80° C.) to provide a white powder of an amorphous solid electrolyte. The resulting white powder was heated in vacuum at 195° C. for 2 hours to provide a white powder of a crystalline solid electrolyte. In an XRD spectrum of the crystalline solid electrolyte, crystallization peaks were detected at 2θ=20.2° and 23.6°, which confirmed that a thio-LISICON Region II-type crystal structure was contained. The resulting crystalline solid electrolyte had an average particle diameter (D₅₀) of 4.5 μm and an ionic conductivity of 5.0 mS/cm.

An InLi foil (having a layer structure of In: 10 mmφ×0.1 mm/Li: 9 mmφ×0.08 mm/SUS: 10 mmφ×0.1 mm, wherein “/” means the boundary of the layers) was provided on the electrolyte for separator on the side thereof opposite to the measurement powder (1), and was pressed once at 6 MPa/cm². The cell was fixed with four screws with insulators interposed for preventing short-circuit between the measurement powder (1) and the InLi foil, and the screws were fixed at a torque of 8 Nm to provide a measurement cell.

The resulting measurement cell was connected to a measurement instrument (“VSP-300” (model number)” manufactured by Bio-Logic Science Instruments, Ltd.), and a CV curve was obtained under the following conditions.

Measurement temperature: 25° C.

Sweep rate: 0.1 mV/s

Measured range of potential: open circuit voltage (+2.1V)→+5.0V→+2.1V

Number of cycles: two

### Example 1

Into a Schlenk (volume: 100 mL) with a stirring bar, a raw material-containing substance containing 0.59 parts by mass of lithium sulfide, 0.95 parts by mass of diphosphorus pentasulfide, 0.19 parts by mass of lithium bromide, and 0.28 parts by mass of lithium iodide as solid-electrolyte raw materials were introduced under a nitrogen atmosphere. The stirring bar was rotated, and then, tetramethylethylenediamine (TMEDA) as a complexing agent was added so as to give a proportion of 4.45 parts by mole relative to the parts by mole of lithium atoms (0.133 parts by mole) contained in the raw materials (i.e., 4.45 parts by mole—TMEDA/parts by mole—lithium atoms) (so as to give 20 mL per 2.0 g of the total amount of the solid-electrolyte raw materials), and stirring was continued for 12 hours to provide a complex-containing substance. The complex-containing substance was dried in vacuum (room temperature: 23° C.) to provide a powder of a complex. Next, the powder of the complex was heated in vacuum at 120° C. for 2 hours to remove the complexing agent from the complex, thus providing a complex degradation product. The complex degradation product corresponds to the reaction product which is obtained by mixing a raw material-containing substance containing a lithium atom, a sulfur atom, a phosphorus atom, and a halogen atom.

The resulting reaction product was heated in vacuum at 200° C. for 2 hours to provide a crystalline product (the heating temperature for providing a crystalline sulfide solid electrolyte (in this Example, 200° C.) is the “crystallization temperature”.).

Next, into a vessel with a stirring blade, 80 g of the resulting crystalline product was introduced, 740 mL of heptane and 110 mL of diisopropyl ether (DiPE) were added thereto, and the mixture was stirred for 10 minutes to provide a slurry. The resulting slurry was subjected to a grinding treatment for 5 minutes using a bead mill capable of performing a cycle operation (“LABSTAR Mini LMZ015 (trade name)” manufactured by Ashizawa Finetech Ltd.) while circulating the slurry under prescribed conditions (diameter of beads: 0.3 mmφ, amount of beads: 456 g (amount of filling beads relative to grinding chamber: 80%), pump flow rate: 400 mL/min, peripheral speed: 6 m/s).

Furthermore, the slurry resulting from the grinding treatment was dried in vacuum at a room temperature (23° C.) to provide a crystalline sulfide solid electrolyte. The integrated power in the grinding treatment was 140 (Wh/kg).

The average particle diameters (D50) of the resulting powders of the reaction product, crystalline product, and crystalline sulfide solid electrolyte were measured, and then, were respectively 4.30 μm, 4.65 μm, and 0.13 μm. The ionic conductivities of the crystalline product and crystalline sulfide solid electrolyte were measured, and then, were respectively 4.3 (m S/cm) and 3.7 μm (m S/cm).

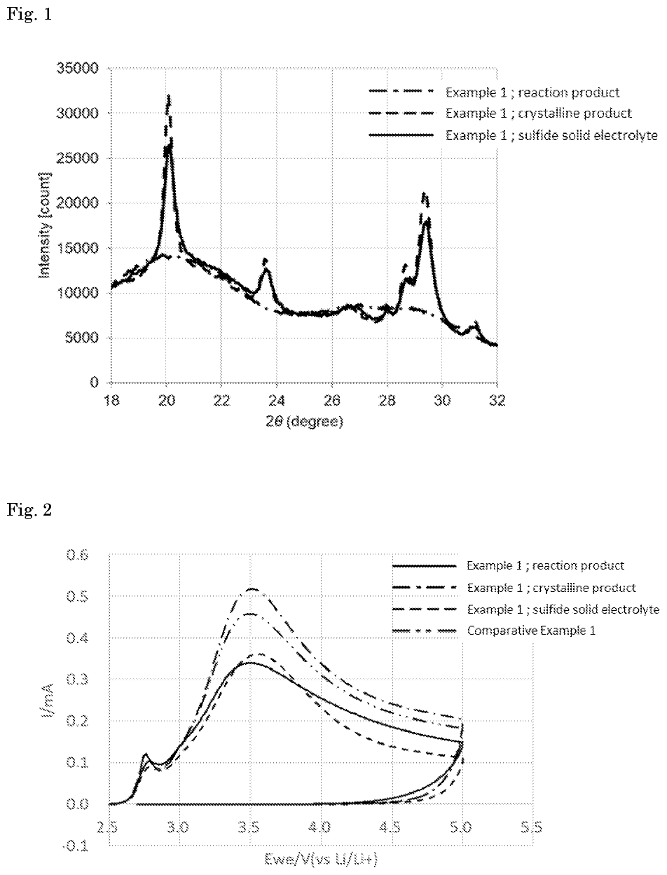

The resulting powders of the reaction product, crystalline product, and crystalline sulfide solid electrolyte were subjected to an XRD measurement. The results are shown in FIG. 1.

The resulting powders of the reaction product, crystalline product, and crystalline sulfide solid electrolyte were subjected to a CV measurement (oxidation current measurement) according to the method as described above. The results are shown in FIG. 2.

### Comparative Example 1

The crystalline sulfide solid electrolyte obtained in Example 1 was heated again in vacuum at 200° C. for 2 hours. The resulting powder was subjected to a CV measurement (oxidation current measurement) according to the method as described above. The results are shown in FIG. 2.

As is seen in the results shown in FIG. 1, the reaction product obtained in the Example had a halo pattern, and it was found that the reaction product was an amorphous sulfide solid electrolyte.

In both of the crystalline product obtained in the Example and the sulfide solid electrolyte obtained by subjecting the crystalline product to a grinding treatment, crystallization peaks were detected mainly at 2θ=20.2°, 23.6°, and 29.5°, which confirmed that those were a crystalline sulfide solid electrolyte having a thio-LISICON Region II-type crystal structure. However, since the peak intensities of the sulfide solid electrolyte obtained by subjecting the crystalline product to a grinding treatment were lower than the peak intensities of the crystalline product, it was found that the crystal structure had been reduced and at least a part of the surface had been amorphized.

As is seen in the results shown in FIG. 2, the crystalline sulfide solid electrolyte obtained by the production method of this embodiment had an oxidation current of 0.36 mA which was as small as that of the reaction product (amorphous sulfide solid electrolyte) which was 0.34 mA, and it was found that the crystalline sulfide solid electrolyte had a superior oxidation resistance although it was a crystalline sulfide solid electrolyte.

On the other hand, the oxidation current of the crystalline product in Example 1 was 0.51 mA, which was extremely larger than that of the reaction product and that of the sulfide solid electrolyte obtained by subjecting the crystalline product to a grinding treatment, and it was found that the crystalline product did not have an oxidation resistance. The powder in Comparative Example 1, which was obtained by heating the crystalline sulfide solid electrolyte obtained in Example 1 to crystallize an amorphized part existing as at least a part of the surface, showed an oxidation current of 0.46 mA, which was larger than that of the crystalline sulfide solid electrolyte obtained in Example 1 but was slightly smaller than the oxidation current of the crystalline product in Example 1. This is considered to be an effect due to a remaining amorphized part.

### INDUSTRIAL APPLICABILITY

According to the production method of a crystalline sulfide solid electrolyte of this embodiment, it is possible to provide a crystalline sulfide solid electrolyte that has a superior oxidation resistance while suppressing granulation, an increase in the specific surface area, and a significant reduction in the ionic conductivity.

The crystalline sulfide solid electrolyte of this embodiment obtained by the production method of this embodiment is suitably used in an electrode combined material, and in a lithium ion battery, in particular, in a lithium ion battery for use in information-related instruments and communication instruments, such as personal computers, video cameras, and mobile phones.

1. A method for producing a crystalline sulfide solid electrolyte, the method comprising
mixing a raw material-containing substance containing a lithium atom, a sulfur atom, a phosphorus atom, and a halogen atom to provide a reaction product,
heating the reaction product to provide a crystalline product, and
subjecting the crystalline product to a grinding treatment performed at an integrated power of 1 (Wh/kg) or more and 500 (Wh/kg) or less to amorphize at least a part of a surface of the crystalline product.

2. The method according to claim 1, wherein the mixing is performed using a grinder.

3. The method according to claim 1, wherein the mixing comprises
mixing the raw material-containing substance in the presence of a complexing agent to provide a complex, and
heating the complex to provide a complex degradation product.

4. The method according to claim 1, wherein the crystalline sulfide solid electrolyte is a sulfide solid electrolyte that has a thio-LISICON Region II-type crystal structure.

5. A crystalline sulfide solid electrolyte comprising
a lithium atom, a sulfur atom, a phosphorus atom, and a halogen atom,
wherein the crystalline sulfide solid electrolyte has an amorphized part as at least a part of a surface thereof.

6. The crystalline sulfide solid according to claim 5, wherein the crystalline sulfide solid electrolyte has a reduction rate in an oxidation current as measured by a cyclic voltammetry measurement of 10% or more, the reduction rate being calculated by the following expression:
reduction rate in oxidation current (%)=(oxidation current 2−oxidation current 1)/oxidation current 2×100
where
oxidation current 1 is oxidation current of the crystalline sulfide solid electrolyte that has the amorphized part as at least a part of the surface (mA), and
oxidation current 2 is oxidation current of the crystalline sulfide solid electrolyte before providing the amorphized part as at least a part of the surface (mA).

7. The crystalline sulfide solid electrolyte according to claim 5, wherein the crystalline sulfide solid electrolyte is a sulfide solid electrolyte that has a thio-LISICON Region II-type crystal structure.

8. An electrode combined material, comprising
the crystalline sulfide solid according to claim 5 and an electrode active substance.

9. A lithium ion battery comprising at least one of
the crystalline sulfide solid according to claim 5 and
an electrode combined material containing the crystalline sulfide solid electrolyte and an electrode active substance.
